(19) United States
(12) Patent Application Publication
(10) Pub. No.: US 2002/0065849 A1
(43) Pub. Date: May 30, 2002

(54) Method and system for integrating network-based functionality into productivity applications employing word processing documents

(76) Inventors: Charles H. Ferguson, Berkeley, CA (US); Alice K. Malone, New York, NY (US); Alan C. Warren, Pound Ridge, NY (US); Dan Woods, New York, NY (US); Shera Ahmad, New York, NY (US); Hung-Chou Tai, New York, NY (US)

Correspondence Address: MORGAN & FINNEGAN, L.L.P., 345 PARK AVENUE, NEW YORK, NY, 10154, US

(21) Appl. No.: 09/929,854

(22) Filed: Aug. 14, 2001

Related U.S. Application Data
(63) Continuation-in-part of application No. 09/675,424, filed on Sep. 29, 2000.
(60) Provisional application No. 60/217,361, filed on Jul. 11, 2000.

(51) Int. Cl. G06F 15/00

(52) U.S. Cl. 707/513

(57) ABSTRACT

A system and method for providing network-based functionality to a word processing document includes, on the client side, a productivity application which is augmented with network-enabling software that provides users with new network-based functionality, which may be accessed within the productivity application. The network-enabling software of the present invention enables users to generate and modify word processing documents by embedding network-enabling objects that can launch and make use of network-based functionality from within the productivity application. The invention further includes remote server support for the network-enabling software that augments the personal computer application, and as well as providing support for the resulting word processing document. Network-based content may be placed, for example, in a table, at a specific insertion point or within an embedded portion of another document type within a word processing document. The network-based content may be static or may be dynamically updated based upon a change in the network-based content at the network source. The end user may selectively decide to refresh network based content objects at their discretion and at any time during the use of the word processing document.

### CROSS-REFERENCE TO RELATED APPLICATIONS

The present application claims priority under 35 USC § 119 to U.S. Provisional Patent Application Serial No. 60/217,361, filed on Jul. 11, 2000, for “System And Method For Integrating Network-Based Functionality Into Productivity Application” and is a continuation-in-part of U.S. patent application Ser. No. 09/675,424 entitled “A Method And System For Integrating Network-Based Functionality Into PC Applications And Documents” filed on Sep. 29, 2000 and is further related to U.S. patent application Ser. No. ______ entitled “A Method and System for Integrating Network-Based Functionality Into Productivity Applications Employing Spreadsheets,” the entirety of which are each hereby incorporated by reference.

### FIELD OF THE INVENTION

The present invention relates generally to a method and system for providing network-based functionality within productivity applications and documents, and more particularly, to a system and method for embedding network-enabling objects into word processing documents and providing network-based functionality thereto.

### DESCRIPTION OF RELATED ART

There exists today a rich class of end user applications, generally termed “productivity applications,” which may be used to create, view and modify personal computer (PC) documents. Examples include MICROSOFT OFFICE, MICROSOFT WORKS, COREL WORDPERFECT SUITE, and the like. These are readily distinguishable from Internet browsing applications which are used to view content on the Internet, since productivity applications have no network-based functionality, as is found in Internet browsing applications. Readily available productivity applications include those used for (1) creating word processing documents which manage and manipulate textual and graphical data, (2) creating documents drawings and illustrations, such as publishing programs, and (3) creating blue prints schematics, such as computer-aided design (CAD) programs. Documents created and managed by such applications are typically either stored on a local hard drive of a personal computer (PC) or other computing device running the productivity application or a file server on a local network serving that PC. The content of these documents is generally self-contained. Therefore all content presented to the user by a productivity application is stored within the documents themselves.

On the other hand, there exists a vast quantity of information and variety of services that are hosted remotely and accessible by diverse users through a network. A web browser, for example, is a convenient vehicle for accessing such content and even for hosting simple applications that are downloaded from the network which work with such remote information and services. Such simple applications may manifest themselves as more advanced web pages, Java applets, browser “plug-ins”, or the like. The extended functionality supported by such simple applications often attempts to recreate a segment of functionality found in an existing desktop application. However, none of these additions to web browsers (or other network clients) incorporate the full functionality of commonly available productivity applications. Moreover, as additional functionality is deployed to web browsers in attempts to raise their level of functionality, bandwidth requirements increase causing the application to become more prohibitive to download.

In general, documents managed by productivity applications are self-contained and do not allow viewing or manipulation of remote content or access to functionality provided by remote systems and servers on a network. Certain productivity application allow users to embed static web page links or e-mail address links into a document created by the underlying productivity application. These productivity applications allow users to launch Internet clients by clicking on the link. However, it is important to note that the result of performing such an operation from within the productivity application is for the underlying productivity application to separately launch the corresponding Internet client, essentially passing the end user to a distinctly new application environment. Since the content being viewed in the Internet client, such as a web page or a new e-mail, cannot be directly displayed by the original underlying productivity application, the user is forced to manually paste the content within the productivity application in order for the productivity application to be able to manipulate or display such content. Even when such pasting is performed, any change to the underlying web page or e-mail will not be updated within the productivity application without performing further pasting. Accordingly, manipulation of network-based content within a productivity application as disclosed herein is heretofore unknown.

Common mechanisms for deploying and utilizing network technologies include Internet clients such as web browsers, media players, and e-mail applications. Examples include INTERNET EXPLORER, MICROSOFT OUTLOOK, and NETSCAPE NAVIGATOR. Similarly, the content presented and manipulated by these various Internet clients cannot be integrated fully into the productivity application's environment such that the content can then be manipulated by the native functionality and tools resident within the productivity application. As a result, while such browsers, media players, e-mail clients, and other network technologies allow access to information on the Internet or other networks, they do not provide the functions and operations that are typically performed by a productivity application. For example, while a browser allows a user to search the World Wide Web, one cannot directly perform ad-hoc analysis of stock data retrieved from the Internet using models running within a spreadsheet application. As a result, end users must manually move the content into a productivity application geared towards such analysis.

Attempts have also been made to receive and collect remote content from external sources from within a productivity application for use toward particular specialized tasks. For example, certain personal financial management applications retrieve stock data from the Internet and bring the data into local views to augment existing content. Unfortunately, once the information has been “imported” the local view remains static, instead of updating itself automatically as the remote content changes. Moreover, while the ability to integrate this imported static information with local content or distributed content from other sources exists in certain limited situations, no means are provided by the productivity application to extend the access capabilities to include other sources of remote content. Users are therefore limited solely to the types of information/data provided by the remote information source.

At the same time, other productivity applications collect and extract data/information from multiple sources and bring the data/information into some central document associated with a productivity application, such as spreadsheets, databases and the like. These productivity applications provide the capability to extract data/information from one or more sources and marshal the data/information into one central location. However their functionality is primitive. For example, a user may be limited to extracting particular data (such as a table of data, but not an individual row or a single paragraph) from a public or static web page, or unable to supply required credentials to gain access to a private web site. Additionally, the functionality exists solely within the application at hand (a user cannot for example apply a query tool for one application to seamlessly retrieve data for another application). These existing tools are merely provided as limited enhancements to the existing application, but fail to provide a platform for development of a wide range of enhanced functionality for said application.

Furthermore, constructing distributed applications that manipulate remote content but execute within a network client such as a browser represents an onerous task at best. The remote content cannot be saved locally and manipulated while disconnected from the remote source and later reused when connected to the original remote location. Additionally, as mentioned above, as the level of functionality approaches that of a productivity application, the resulting browser application becomes prohibitively large for typical distribution via Internet download.

Moreover, existing desktop applications may provide a method of extending their native capabilities via a scripting interface. However these scripting environments are often inferior to typical robust development platforms. When attempting to construct solutions in these environments, developers must resort to more complex code and debugging methods, thereby additionally raising development costs and reducing the availability of developers who may have the necessary skill sets to implement such solutions. Therefore a need exists for a more robust development platform, allowing a developer or end user to quickly build and deploy applications that expose network functionality integrated with productivity application functionality.

As such, on one hand, existing productivity application fail to incorporate Internet and/or other general network-based access capabilities as an integral part thereof. On the other hand, Internet clients fail to incorporate the full scope of productivity application functionality therein. As a result, these productivity applications cannot be readily utilized for network-based operations and functionality. Furthermore, available productivity applications fail to provide solid mechanisms for incorporating distributed and remote information into their respective documents. For example, while the ability to receive network-based information, such as stock quote streams, in real time, directly into a spreadsheet, or to receive live video feeds within a document within existing productivity applications, exists today in certain limited situations, coupling dynamic remote content with documents that are automatically updated when the remote content changes requires functionality currently unavailable in existing productivity applications. Thus, a user is denied access beyond the traditional functions provided by the standard productivity application and/or Internet clients, and cannot create documents that leverage these network-based features.

In view of these disadvantages, there is a need for a system that allows seamless and integrated access to both local, as well as distributed (e.g. network-based), content and information. There is a further need to extend the network access and utilization capabilities of existing productivity applications, such as Word Processing Applications. In addition, there is a need to provide a general, as well as extensible, framework for extending the network access and utilization capabilities of existing productivity applications. Furthermore, there is a need for a system to create, manage and utilize documents that contain a mix of immediate as well as distributed, content. There is further a need for managing word processing document so that they can behave as Internet applications themselves. There is yet a further need to enhance the packaging and delivery of documents so that they are suitable for web application deployment. Additionally, there is a need for managing access to and use of local content based on remote settings and controls.

### SUMMARY OF THE INVENTION

The present invention overcomes the above-mentioned disadvantages found in existing technologies. One aspect of the invention provides a general system for augmenting existing productivity applications, such as word processing documents and the like, with network-based functionality therein. Users are provided with the ability to utilize and leverage the resources of the network/Internet from within such documents opened in their productivity application. For example, the augmented productivity application of the instant invention allows the user to browse the Internet, read and write emails, send and receive instant messages, perform page scraping, receive stock quotes in real time, access remote databases over the Internet, or perform other similar network-based functions from within a productivity application document, and in particular, a word processing document, and be able to use their productivity application functionality with both local and remote content in concert.

In one embodiment of the present invention, a word processing document with network-based functionality is disclosed. The word processing document is used with the productivity application augmented with network-functionality software that is resident in computer memory. The word processing document is coupled with network-enabling objects embedded in, for example, one or more cells of a table within the document that are configured to provide network-based functionality to the document.

The invention described herein supports integration of a wide range of network-based user interfaces, content, data, and functionality into productivity applications utilizing word processing documents. The networks that can be used in conjunction with this technology include the Internet, as well as other networks.

The invention described herein enables the development, deployment, and use of these network-based services and documents with network-based functionality. The invention allows integration of a wide range of network-based services, including Internet-based, user interfaces, content, data, and functionality into the augmented productivity application and also into word processing documents used or produced by such augmented productivity applications. Thus, the invention enables professional developers as well as end users to develop productivity application-based, network-enabled documents and applications by using augmented versions of productivity applications with which they are already familiar. This simplifies and improves the development of network-based applications or documents.

The present invention also provides a client/server architecture wherein one or more users may connect to a network, comprising one or more independent servers, for receiving network-based functionality within their word processing productivity application.

The present invention may include an architecture that involves four software components. The first component is a document-independent, run-time client-side code, through which a productivity application is extended by network-enabling software that facilitates access to network-enhanced services and functionality from within the application environment. The second component of the architecture is the enhanced word processing document, which includes network-enabling objects. The third component of the architecture is a design tool for creating the enhanced personal computer document. The fourth component of the architecture is server-side code that manages interactions between clients and Internet resources and interactions among multiple end users.

These aspects and other objects, features, and advantages of the present invention are described in the following Detailed Description which is to be read in conjunction with the accompanying drawings.

### BRIEF DESCRIPTION OF THE DRAWINGS

FIG. 1A is a block diagram of an exemplary embodiment of a word processing document in a productivity application augmented by a productivity application extender, wherein the word processing document may contain network-enabled objects;

FIG. 1B is a block diagram of exemplary embodiment of a word processing document in a productivity application augmented by a productivity application extender in cooperation with a component object model (COM) interface code;

FIG. 1C is a schematic diagram of exemplary software modules supporting the network-enabling object in accordance with the present invention;

FIG. 2 is a schematic diagram of a productivity application extended by a client extender in accordance with one embodiment of the present invention;

FIG. 3A is a schematic diagram of one embodiment of network-enabling software for use by software developers;

FIG. 3B is a schematic diagram of one embodiment of network-enabling software for use by users;

FIG. 4 is a schematic flow diagram depicting a process for providing network-enabling software to a productivity application of the present invention;

FIG. 5 is a block diagram of a productivity application that provides users with built-in tools for creating word processing documents with network-based functionality;

FIG. 6 is a schematic diagram of a word processing application incorporating network functionality in a word processing document in accordance with the present invention;

FIGS. 7A-7D are schematic diagrams of different states of communication between the network-enabling objects in a word processing document with one or more controls installed on a device running a productivity application;

FIG. 8 is a schematic flow diagram depicting the process for creating a word processing document with network-enabling objects embedded therein;

FIG. 9 is a schematic flow diagram depicting the process for launching network-based functionality with a word processing document;

FIG. 10 is a schematic block diagram depicting the client/server system of one embodiment of the present invention for providing network-based functionality with a word processing document;

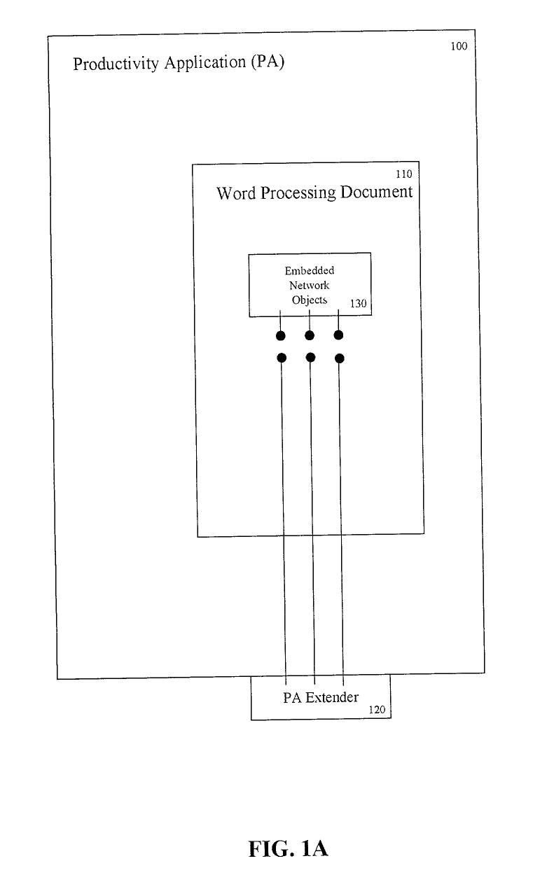

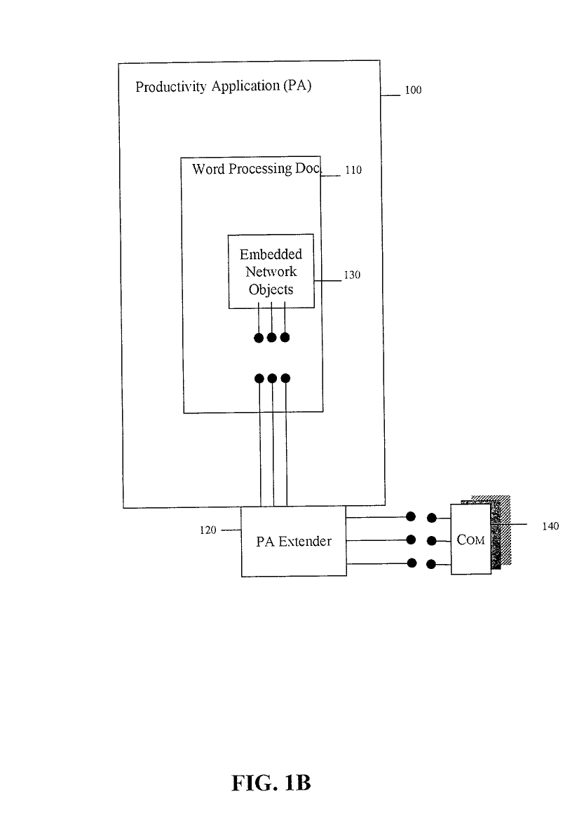

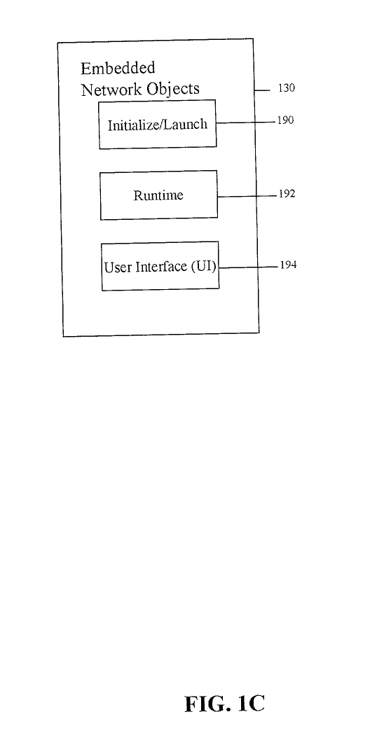

FIGS. 1A-11C are depictions of the placement of exemplary network-based content within a word processing document in accordance with various embodiments of the present invention;

FIG. 12 is a schematic block diagram depicting the client/server system of an embodiment of the present invention for developing and accessing a web page as an embedded object that is produced using a word processing document.

FIG. 13 is a schematic flow diagram depicting the process for developing and accessing a web page as an embedded object that is produced using a word processing productivity application;

FIG. 14 is a schematic flow diagram depicting the process of the operation by a user to use a web page created in accordance with the process of FIG. 13;

FIGS. 15 is a flow chart illustrating an exemplary process for creating a network-enabled table within a word processing document according to the present invention;

FIGS. 16A-16G are exemplary screen shots of exemplary software tools used in conjunction with the process of FIG. 15;

FIG. 17 is a flow chart depicting an exemplary process for placing network-based text within a word processing document according to the present invention;

FIGS. 18A-180 are exemplary screen shots of software tools used in conjunction with the process of FIG. 17.

With reference to the following detailed description, the aforementioned drawings will be described in greater detail below.

### DETAILED DESCRIPTION OF THE INVENTION

The present invention relates to a system and method for providing network-based functionality to a word processing document within a productivity application. Initially, a productivity application, and in particular, a word processing productivity application such as MICROSOFT WORD, MICROSOFT WORDPAD and COREL WORDPERFECT, or other a software program used for a particular desired task, such as to create a functional word processing document, is augmented with network-enabling software that allows users to provide new features to the productivity application. The network-enabling software of the present invention enables users to generate, modify and utilize word processing documents with embedded network objects. Such objects can work in conjunction with the network-enabling software to launch and utilize network-based functionality from within the word processing document. The present invention enables the use of a wide array of public and private network-based based content and services including, but not limited to, content and web services and other Internet-based content and services, within a productivity application, such that these services can be viewed and used within such applications, and within the documents associated with these applications.

It should be noted that the present invention, even when described in connection with the Internet specifically, may be applied equally to local area networks (LANs), private “Intranets,” hybrid public-private “Extranets,” virtual private networks (VPN), and other networks.

The services that can be provided and used within a productivity application include web browsing, electronic mail (e-mail), instant messaging, digital rights management (DRM), remote database access over the Internet, and other Internet-based services, as well as combinations of these content and services.

According to an embodiment the invention, once the network-enabling software has been installed on a personal computing device, the network-enabling software may automatically load when the augmented productivity application is loaded. Users of the augmented productivity application may load existing word processing documents or create new ones with the augmented productivity application. Once a word processing document is open within the augmented productivity application, the user is able to make any of the standard operations thereto, such as creating, adding or modifying content therein. Furthermore, the augmented productivity application allows the user to embed network-enabling objects in the word processing document by a plurality of mechanisms, with the optional ability to automatically update such content in the word processing document if the content from the online source changes.

According to the invention, the network-enabling objects embedded in a word processing document allow users to launch network-based operations from within the word processing document when the associated productivity application has the network-functionality software running alongside. Such network-enabling objects may allow users to perform web browsing, e-mail, instant messaging, remote database access over the Internet, DRM, and/or a plurality of other network-based operations consistent with the purpose of the present invention.

According to the invention, both fixed and customizable objects may be placed within individual word processing documents to provide network-based functionality thereto. The network-enabling objects can either be visible to the user within the document or hidden. The network-enabling objects may contain data, UI elements, and code such as Visual Basic scripts. According to the invention, the network-enabling objects can present the user with specific options, and act in response to user-provided information and choices, and/or they may take network-related actions automatically, driven solely by software commands.

As noted above, the actions taken by the network-enabling objects placed within word processing documents can include any combination or sequence of a wide array of Internet-related actions, including but not limited to checking or sending e-mail, checking or sending Internet-based voicemail, querying remote databases over the Internet, requesting or updating a web page, invoking a remote application over the Internet, establishing a real-time data feed with a specific Internet data source, or sending a real-time message.

It should be noted that the ability to make use of these services and functionality is not restricted to existing productivity application and word processing documents. Such services and functionality can also be provided through future productivity applications not yet developed and through augmented or enhanced future versions of existing applications and document types, or through wireless, laptop, handheld, or other computing devices.

According to another embodiment, the word processing document may be provided with an installation facility to install the network-enabling software on a computing device where the spreadsheet resides but where the underlying productivity application has not been provided with the network-enabling software of the present invention. The invention discloses a system for automatic installation of the network-enabling software so that new word processing documents with network-enabling objects may be created, manipulated, enhanced and supported.

The invention further discloses the packaging of network-based functionality via software development kits (SDKs) and application programming interfaces (APIs) usable by professional productivity application developers. It will be appreciated that the functionality provided by the invention, the architecture in which they are embedded, and the APIs through which they can be utilized, greatly simplify and improve the development of new, network-enabled productivity applications and word processing documents. This functionality can also be provided for network-specific documents such as e-mail messages that are processed by SMTP/POP e-mail clients.

In general, the present invention may include an architecture that involves four software components. The first component is a document-independent, run-time client-side code, through which a personal computer application is extended by network-enabling software that facilitates access to network-enhanced services and functionality from within the application environment. The second component of the architecture is the enhanced personal computer document, which includes network-enabling objects. The third component of the architecture is a design tool for creating the enhanced personal computer document. The fourth component of the architecture is server-side code that manages interactions between clients and Internet resources and interactions among multiple users.

The runtime client-side code may be configured as one or more distinct sub-components. For example, one sub-component may constitute generic client-side code that handles aspects of system operation common to all applications, while a second sub-component may be application specific (e.g., the portion of the code that controls the application's unique user interface). This runtime support code at the client can be developed using any of a number of programming languages, such as C, C++, Java and Visual Basic. One of the functions of the runtime client-side code is to wrap and package low-level transport protocols such as Transmission Control Protocol/Internet Protocol (TCP/IP) and hyper-text transfer protocol (HTTP) into elements that can be manipulated and that provide specific, high-level functional capabilities, such as wrapping Simple Mail Transfer Protocol SMTP to provide easy-to-use email capabilities, wrapping HTTP Web page access and parsing to allow easy access to live information on web pages. The wrapping is done in a layered fashion so that users can create and/or manipulate the elements without having any programming capabilities whatsoever, yet developers can leverage scripting or lower-level programming to access more advanced facilities.

The second functionality of this runtime client-side code is to integrate with the hosting productivity application. This integration falls generally into three categories. The first category simply provides a seamless runtime environment so that these services run and are available from within the application process. This makes the packaged services available for calling from within scripts in enhanced documents and from application code itself, and is generally enabled by running at least part of the support code as an add-in to the productivity application itself. The second category of integration is at the user interface (UI) level, where the enhanced functionality elements are exposed as operations on toolbars and menus, and as objects in enhanced documents themselves. This integration is enabled through a combination of standard windowing facilities on the client platform, and use of the application and document object models to allow integrated rendering of the UI elements and handling of associated events. This, for example, enables an end-user to drag an email button that has been provided on a toolbar into a document, such that the button is rendered as part of the document and that when the button is pressed a pre-defined message is emailed to the author of the document or other specified recipient. The end-user would need no programming ability to perform this embedding and configuration, having only to fill in the content of the message and the name or email address of the recipient. The third integration category relates to embedded applications, and involves controlling the behavior of the hosting application itself when an embedded application has been placed in “run mode”. Document-based applications are generally not designed to behave as application containers for embedded applications, and when used in this manner must be managed carefully to prevent unwarranted operations by users. This management or control can involve blocking certain operations, prevention of the embedded application from being rearranged or reconfigured, or modifying and/or augmenting various ordinary tasks such as saving a local copy of the embedded application enhanced document. This control is achieved again by packaging some or all of the runtime support code as an extension (such as an add-in or a plug-in) so that it runs in close cooperation with the hosting productivity application, and in working with the productivity application extension to change the productivity application behavior. The productivity application extension can change the productivity application behavior by a combination of handling the entry points and events, overriding handling by the productivity application itself, and extending the productivity application object model through new, custom code.

In this runtime environment, an augmented productivity application may allow an end-user to download and open word processing documents within the productivity application's native environment. In one embodiment, the document may constitute a web page, or a productivity application version thereof, downloaded from a web server. The augmented desktop application and enhanced document together form an Internet or network-enabled application that facilitates access to remote services and functionality while retaining functionality inherently provided by the desktop application. Access to distributed services may be via any network or protocol.

The enhanced word processing document includes Internet-enabling objects which can be document specific and placed into a document such as a productivity application-based web page and the like by either a developer or end-user. The UI of such objects can include buttons, lists, menus, and forms. Their functionality can include combinations of Internet or network-based functions such as sending and receiving data, sending and receiving email messages, causing documents to be posted to web sites, and other functions enabled by the technology. The functionality of such objects is specified by custom-developed software, which can be associated with the object's UI, and then activated by software events and/or user-issued commands. Once written, these objects can be separately transmitted via the Internet and stored on client machines for use by developers and users.

In certain embodiments of the present invention, enhanced word processing documents created by a developer can be defined as embedded applications, consisting of three defined elements, namely a wireframe, population data and form data. These data may inserted within (1) a table of the word processing document, (2) an insertion point within the word processing document or (3) within a spreadsheet or other document inserted within a word processing document. Each of these embodiments will be described further below.

The wireframe includes static content and scripting code that is generally not modified during runtime within a productivity application residing on an user's system. The static content also includes the layout configuration of the word processing document viewed by a user, such as fonts and/or colors. The script code allows users or developers to extend the built-in functionality of the productivity application or simply create macros containing often-used packaged sequences of operations (for example, repeatedly creating the same customized chart from a set of data). In the context of the wireframe, the script code may contain code to assist in supporting the present invention.

The population data is dynamically generated data used to populate specified areas within a wireframe during a desktop application's runtime. Typically, such data is supplied by a server and is designated “read only”, but where appropriate the data may be editable, or can be pushed back to the server for other custom processing. Population data may be used in a variety of ways, including to populate fields paragraphs, tables, embedded proprietary objects such as Microsoft Word Text Boxes, strings, and pick lists for display to the user, or transparently as calculation data operated on by the application. It may also be defined to be a function of information maintained in the associated wireframe, user input, or both. It may typically be generated or retrieved upon actions such as startup, connection, or form submission, or a manual refresh request or in real-time in response to remote data changes.

The form data is data that is specified or manipulated at the client by users during runtime. Form data is usually one-way data transmitted from client to server. But in some circumstances it may be desirable to read such data from a server (for example, as cached prior information to pre-populate a user form or as smart defaults for a user form) to pre-fill forms within a wireframe. Form data includes data items, such as data entered into text box prompts (for example, asking for a user's username and password for authentication) and parameterized data entered into defined queries (such as stock ticker symbol as a parameter in a web query).

The design tool for creating enhanced word processing documents augments a productivity application so that a software developer is provided with functionality that is similar to a special-purpose productivity application that is oriented towards the design of complex enhanced word processing documents, services and applications. In the design-time environment, an augmented productivity application can provide a developer with tools for creating the distributed documents described above.

It should be noted that support for the design-time environment is similar to the packaging and functionality described above for the general runtime support except that the integration with and control of the containing application is generally more extensive. In addition, the elements and tools that are exposed to a developer are generally more detailed and in many cases will involve scripting or code to achieve the greatest level of functionality and control. The principal difference in functionality in the developer's design time tools and environment from an end-user's authoring environment is that the former provides extensive controls targeted at defining and managing the behavior of the containing application, while the latter is focused on creating and managing elements in enhanced documents and/or directly accessing the distributed functionality and services of the runtime itself. The design-time support code will generally be packaged as one or more separate add-ins and/or tools from the standard runtime code. Furthermore, the runtime code can be divided along functional boundaries into multiple, separately distributed pieces as well. For example, this runtime could be sub-divided into components or libraries that are completely independent of any particular enabled application (perhaps as a collection of COM objects), an application-specific add-in that provides base end-user tools and support for enhanced documents, and a second application-specific add-in that provides for application and environment control for embedded applications, where the enhanced document is actually intended to be an embedded application and have a distinct design mode and run mode. The development environment may then be packaged as one or more additional add-ins distinct from the above.

The design tool allows the developer to design the distributed word processing documents described above. The developer may be provided with tools that allow him or her to embed Internet or network-related functionality (e.g., automated e-mail notifications) in the word processing document, control the UI that will be presented to the end-user when the document is opened, define population-data sources and how the data is displayed, define business rules, and various other functions within the scope of the present invention.

The developer may also create parallel browser-based views of these distributed documents. The choice of whether to download a browser-based view or desktop-application-based view of a page may be controlled by preferences set by the user and stored at a server. The developer may also wish to augment the browser-based version of the page so that it provides some of the additional functionality included in the productivity application based version. Examples of such network-functionality may include scripting for form-data posting, HTML-based lightweight grid handling, and inserting meta-tags into the browser-based view of a page for managing later wireframe synchronization with the desktop application version.

Since some developers may wish to augment the browser-based version of the web application still further, the invention provides the ability to retain such modifications and enhancements through subsequent desktop application-to-augmented-HTML exports, and push modifications back to the desktop productivity application version where appropriate. A typical example of HTML-side augmentation is inserting client-side scripting to add functionality to the UI beyond that provided by a browser (for example, ornate hover buttons). Additional desktop application-side augmentation might involve a business analyst defining macros and calculations linking various data items within the application.

The invention provides for server-side components that manage interactions between clients and Internet resources and/or interactions among multiple users, the latter greatly facilitating client peer-to-peer operations. Specific services can be characterized by the kind of server support they require. For example, E-mail notifications require basic SMTP mail services. Semi-standardized services can be leveraged for functionality such as remote database access, messaging, conferencing and the like. Custom remote services can be leveraged for accessing proprietary information feeds (such as real-time stock quotes), document archives and repositories, corporate workflow systems and the like. For these latter categories, the present invention adds value by providing a generalized framework for finding and accessing the remote services, and for opening standardized connections for communication and data transfer to the client productivity application.

With reference to the figures, various embodiments of the present invention will now be described in greater detail. FIG. 1A provides an illustration of a system in accordance with the present invention. A productivity application 100 is provided with a word processing document 110. In accordance with the present invention, the productivity application 100 is not limited to any particular task, form or vendor. According to the present invention, the computing device is not limited to any particular type of personal computer, and is operable on any machine with a suitable operating system having graphical user interface (GUI) facilities. The operating system for use in the present invention is also not limited to any particular type, and may include MICROSOFT® WINDOWS®, MACINTOSH, UNIX, LINUX, NET BSD, FREEBSD, and the like. This functionality can also be provided to applications running on Personal Digital Assistant (PDA) devices, cellular phones and other “light clients” connected to the Internet via wireless communications.

According to the invention, the productivity application 100 is augmented so that it is capable of developing, using, accessing, manipulating, and displaying network-enhanced word processing documents. Such an augmented productivity application 100, which allows for the creation and use of network-enhanced documents, can essentially be termed an application within an application. The present invention enables access to Internet-based services, data, and functionality within network-enhanced documents, which are developed, edited, and viewed via the augmented productivity application 100. The invention provides for tools, pre-defined scripts, and supporting runtime code that make construction of such enhanced documents in the desktop application's native format simple enough for users, yet flexible and comprehensive enough for developers to rapidly construct complex, powerful applications that leverage both Internet/network services and the client-side functionality of the particular productivity application. Where possible, the technology leverages a built-in script execution capability provided by the productivity application 100, such as Visual Basic for Applications facilities provided by MICROSOFT. Thus, this system provides a powerful environment for developing and using enhanced documents with rich and familiar client-side functionality.

The word processing document 110 is an object that is typically created, used, manipulated, augmented and saved by the underlying productivity application 100. For example, a word processing document is the document where the underlying productivity application 100 may be any version of a word processing application, such as MICROSOFT WORD, MICROSOFT WORDPAD or COREL WORDPERFECT. The word processing document 110 may be provided with embedded or associated code that provides access to distributed, usually Internet-based, services, data and functionality residing on multiple computer systems connected via the Internet or other network. These services and functionality may be made available via the Internet using the typical network protocols, such as HTTP transfer protocol, FTP, SMTP (email), or streaming media.

Productivity application 100 is provided with a productivity application extender 120. The productivity application extender 120 enables users to augment the productivity application 100 with network-based functionality. The word processing document 110 is provided with network-enabling objects 130 that provide network-based functionality to the word processing document 110. The network-enabling objects 130 may be used to provide any network-based functionality from within the word processing document 110 and viewed in its native environment. For example, the network-enabling objects 130 may be used for browsing the Internet, screen scraping, sending and receiving electronic mail (e-mail), instant messaging, chat, internet telephony, streaming media, stock quote retrieval, web page update detection, workflow, conferencing, licensing, automatic notification of a certain event, usage monitoring, replication and synchronization and other similar network-based tasks and content.

The network-enabling object 130, which is placed inside the word processing document 110, can perform a wide range of network-based functions, as specified by a developer. Such network-enabling objects 130 can include UI elements, such as buttons, pick lists, and menus, program code, such as Visual Basic scripts that perform functions, and data 5 elements. These objects can be placed into the word processing document 110 by developers and users, where they remain as part of the word processing document 110 structure, upon saving the word processing document 110.

Coupling the productivity application extender 120 to the embedded network-enabling object 130 provides one or multiple network-based capabilities, such as web browsing and e-mail within the productivity application 100. As a result, the productivity application 100 serves as the UI to the Internet and other networks, which eliminates the need to rely on separate Internet-specific client applications, such as web browsers (e.g., MICROSOFT INTERNET EXPLORER and NETSCAPE NAVIGATOR), e-mail clients (e.g., MICROSOFT OUTLOOK or EUDORA), and media players (e.g., distributed by REAL NETWORK). Furthermore, the provision of web access within the productivity application 100, employing the native data types and facilities of the productivity application 100 for the representation of web pages, allows users to use the web site from within the productivity application 100. This allows users to have access to functions such as browsing pages, navigating through hyperlinks or image maps, entering data in forms, and a variety of other network-based functions.

According to one embodiment of the invention, the productivity application extender 120 may interact with one or more Component Object Model (COM) components on a local computing device to support and provide additional functionality within the productivity application 100 as well as the word processing document 110, as shown in FIG. 1B. COM is a software architecture that allows components made by different software vendors to be combined into a variety of applications. COM defines a standard for component interoperability and provides the underlying support for Object Linking and Embedding (OLE) items and ActiveX controls to communicate with other OLE objects or ActiveX controls. OLE is a framework for a compound document technology, available from MICROSOFT. OLE is a set of APIs used to create and display a compound document. An ActiveX control is a software module based on the COM architecture, which enables a program to add functionality by calling ready-made components that blend in and appear as normal parts of the productivity application. ActiveX controls are typically used to add user interface functions, such as 3-D toolbars, a notepad, calculator or even a spreadsheet. In many cases, COM provides the underlying services of interface negotiation, life cycle management (determining when an object can be removed from a system), software licensing, and event services (putting one object into service as the result of an event that has happened to another object).

According to the present invention, the network-enabling objects 130 communicate with the productivity application extender 120 to enable the document to receive network-based functionality therein. The productivity application extender 120 communicates with the COM component(s) 140 to allow the embedded network-enabling objects 130 in the word processing document 110 to provide additional functionality to the same.

FIG. 1C provides an illustration of one embodiment of the network-enabling object 130 in accordance with the present invention. The network-enabling object 130 is used to launch the network-based functionality within the word processing document 110. The network-enabling object 130 is embedded in the word processing document 110 so that the functionality of the network-enabling object 130 becomes at integral part of the word processing document 110. The network-enabling object 130 comprises two main components, initialization code 190 for initializing and launching the network-based functionality prior to runtime, and runtime code 192 for providing the network-based functionality during runtime. As a result, the initialization code 190 causes the launching of the network-based functionality, while the runtime code 192 enables a user to continuously receive network-based functionality within the word processing document 110.

It should be noted that the initialization code 190 plays no role during runtime, and remains static/dormant during runtime of the network-based functionality. According to one embodiment, the runtime code 192 can be provided with all the necessary functions or routines for enabling the productivity application extender 120 to read the necessary information and then initialize and launch the network-based functionality. According to another embodiment, the word processing document 110 can be embedded with code that includes some of the necessary functions/routines to initialize and launch the network-based functionality, and the initialization code 190 can be provided with the bare minimum routines to merely initialize the network-enabling object 130.

According to one embodiment, the network-enabling object 130 may be provided with a UI 232 that makes the network-enabling object 130 visible to the user. It should be noted that providing the UI 232 for the network-enabling object 130 is strictly optional, since a number of network-enabling objects 130 may be provided such that they are hidden from the user's view while still providing network-based functionality.

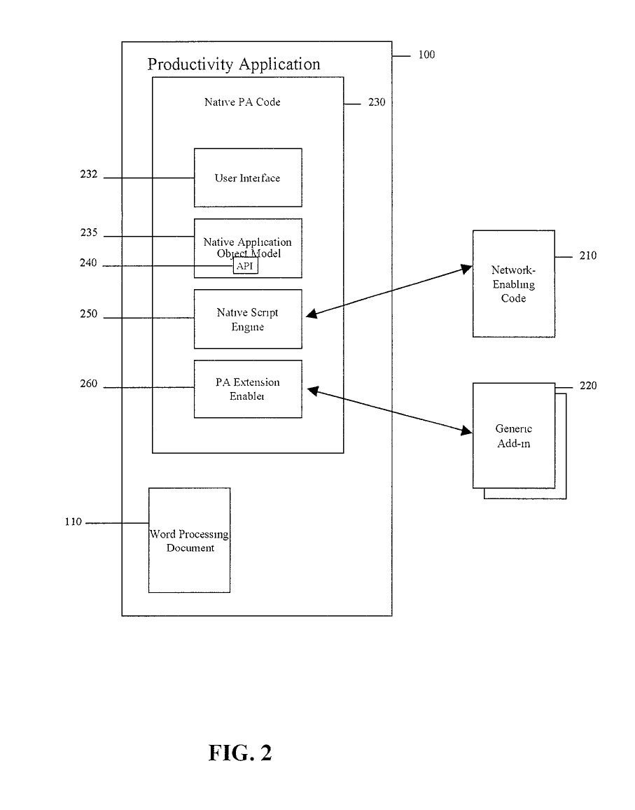

FIG. 2 provides an illustration of a productivity application 100 in association with the network-enabling software 210 of the present invention and other generic add-in(s) 220 that may be supplied by one or more third-party vendors or developers. As noted above, the productivity application 100 is not limited to any particular task, form or vendor. Furthermore, the productivity application 100 may be provided by any vendor, including MICROSOFT, COREL, SUN MICROSYSTEMS and the like.

The productivity application 100 comprises native productivity application code 230. The native productivity application code 230 includes code that makes the productivity application 100 operational and provides the functionality and features that are standard for the productivity application 100. The native productivity application code 230 generally comprises the code that creates and provides the user interface (UI) 232 for the underlying productivity application 100.

The native productivity application code 230 exposes a Native Application Object Model 235. The Native Application Object Model 235 provides a description of an object architecture, including the details of the object structure, interfaces between objects and other object-oriented features and functions. The native object model 235 enables the use of add-ins 220 and network-enabling software 210 so that the functionality of the add-ins 220 and network-enabling software 210 can seamlessly be integrated with the original functionality and features of the productivity application 100.

The native productivity application code 230 may also include an Application Program Interface (API) 240, which may be a part of the Native Application Object Model 235.

The API 240 provides a language and message format used by the productivity application 100 to communicate with the operating system or some other system or control program or communications protocol. The API 240 is implemented by custom-authored components, which leverage the API 240 and manipulate the productivity application 100. The API 240 also provides a method for extending the productivity application 100 by the productivity application extender 130 or other COM objects, allowing software developers to author custom functionality; as a result, the API 240 allows manipulation of the operation of the productivity application 100 from an external source, as opposed to from within the productivity application 100 and/or the word processing document 110. The API 240 provides developers a blueprint of how to manipulate the productivity application 100 by publishing a consistent set of interfaces.

The native productivity application code 230 provides a native script engine 250. The native script engine 250 is a facility in the productivity application 100 that can execute interpreted languages, such as Visual Basic, JScript scripts and/or other types of scripts. The native script engine 250 allows the script code in the word processing document 110 to execute and manipulate the productivity application environment.

The native productivity application code 230 may include a productivity application extension enabler 260 that allows and facilitates the use of add-ins and/or plug-ins with the productivity application 100. The productivity application extension enabler 260 enables add-ins and/or plug-ins that have been added to the productivity application productivity application 100 to be loaded and run automatically when the productivity application 100 is launched. Generally, the productivity application extension enabler 260 is a manifestation of the API 240. As such, the productivity application 100 may either have an API 240 or a productivity application extension enabler 260.

Using the available features of the productivity application 100, a user can create a new word processing document 110 or open an existing word processing document 110 to perform operations thereon. The network-enabling software 210 allows users to embed network-enabling objects into the word processing document 110, which will be described in greater detail below. Once the network-enabling objects are embedded in the document 110, the network-enabling software 210 allows a user to use the network-enabling objects and receive the network-based functionality in their documents 110, as well as use the standard functions and features provided by the productivity application 100.

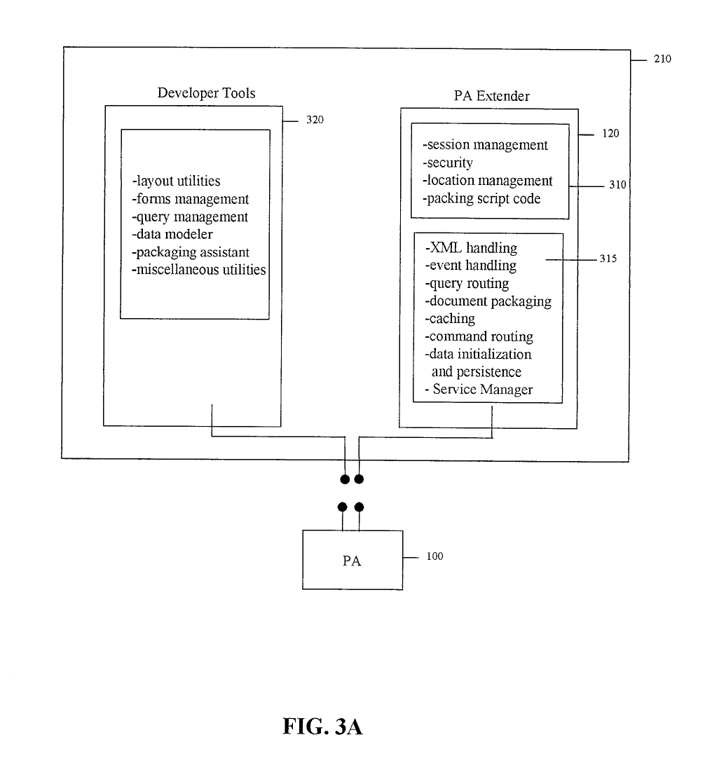

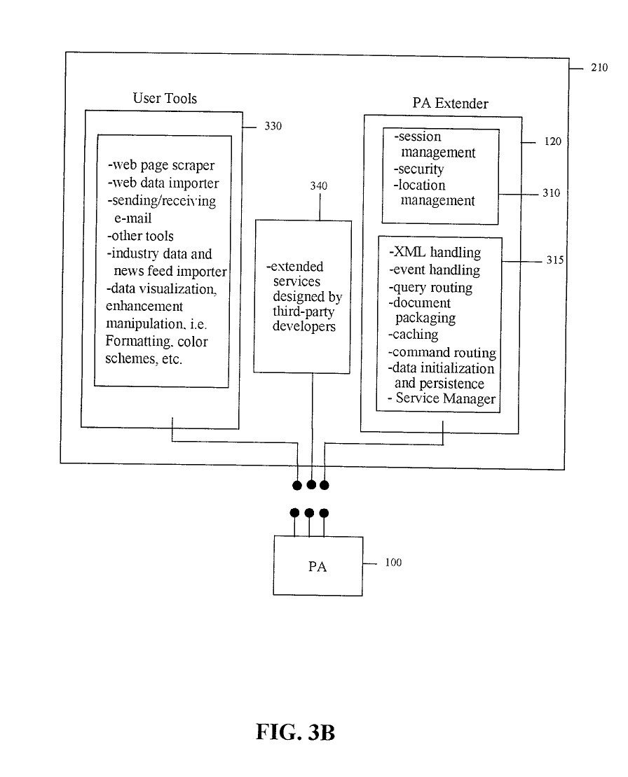

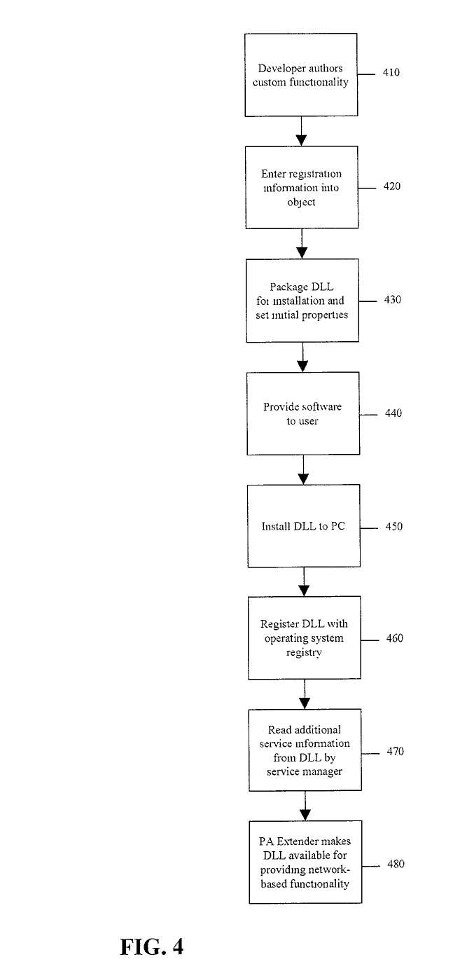

FIG. 3A provides an illustration of one embodiment of the network-enabling software 210. The network-enabling software 210 includes the productivity application extender 120, which provides any standard productivity application 100 with one or more network-based capabilities.

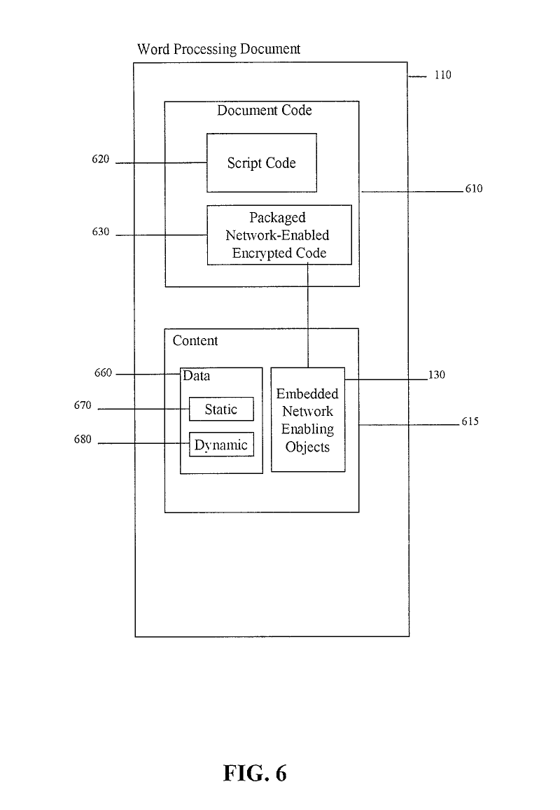

The productivity application extender 120, which provides runtime support, includes network-functionality services 310 as well as application services 315. The network-functionality services 310 may include session management, security and location management that provide network-based functionality, as well as some combination of the individual network-functionality services. The network-functionality services 310 provide runtime support for the network-based functionality. The network-functionality services 310 expose an API with methods than can be called by the network-enabling objects 130 and scripts from within the word processing document 110 to use one or a plurality of network-based functionality. The network-functionality services 310 also includes the base functionality for packing away script code of the word processing document 110 for safe and easy network transport as well as unpacking a script code 620 (FIG. 6) of the word processing document 110 when the word processing document 110 is opened.

The application services 315 may include XML parsing and other handling, event handling and service management, query routing, document packaging, caching, data initialization and persistence, command routing and other similar services, as well as some combination of the individual application services. The application services 315 provide runtime support for the embedded applications and/or network-enabling objects 130 in the word processing document 110.

According to another embodiment, the productivity application extender 120 is a COM component. The productivity application extender 120 is deployed as a dynamic link library (DLL) file, which is not launched directly by the user but may be called by the productivity application 100 for receiving network-based functionality. As such, the productivity application extender 120 may also be used by any application running system-wide, in addition to being accessible within the productivity application 100. It should be noted that designing the productivity application extender 120 as a DLL file is just one method of deployment, and various other manners of deployment exist within the scope of the present invention. As such, each functionality of the productivity application extender 120 may be provided as a separate routine, class or function in the DLL file, which may be packaged to include one or more of the network-based functionality listed above.

It should be noted that the productivity application extender 120 may be provided with just the network-functionality services 310 or just the application services 315 or a combination of the two. Furthermore, the scope of the present invention is not limited by the types of services included in the network-functionality services 310 and/or the application services 315.

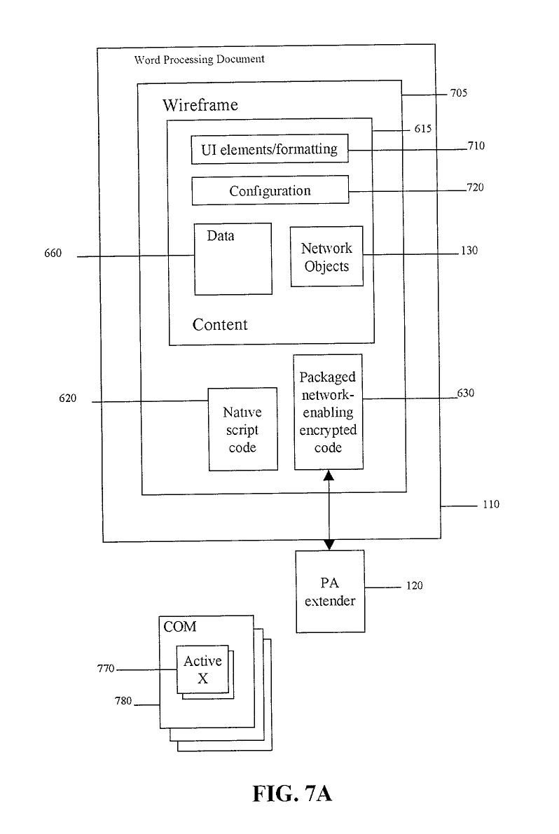

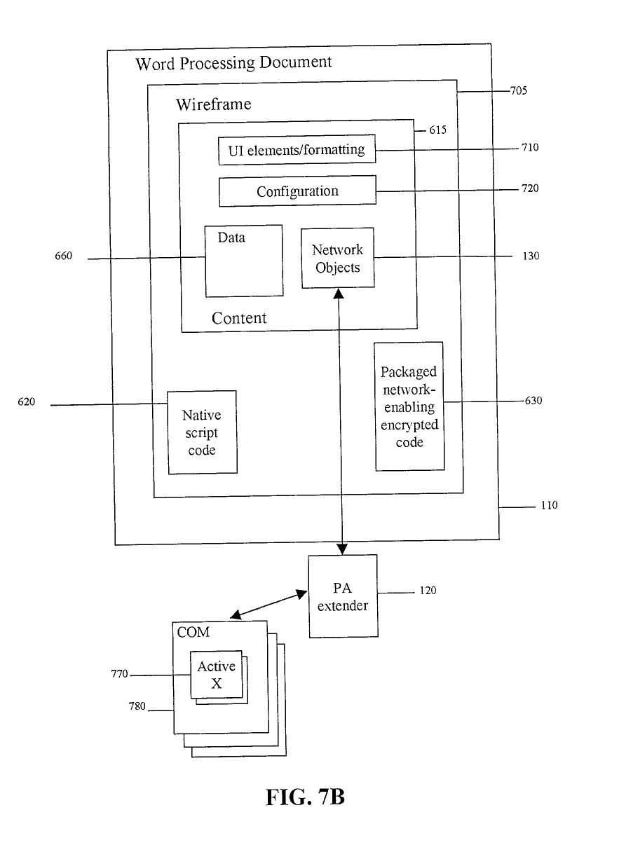

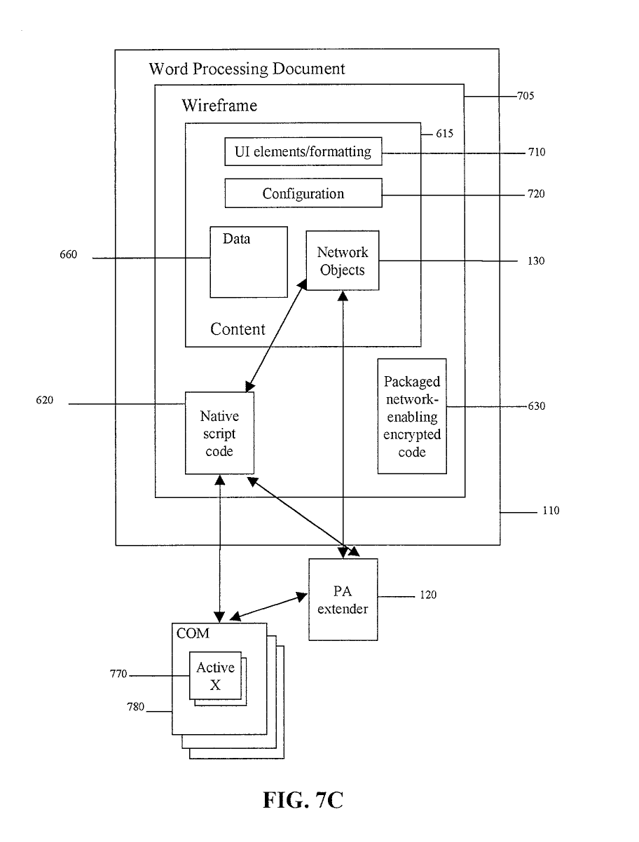

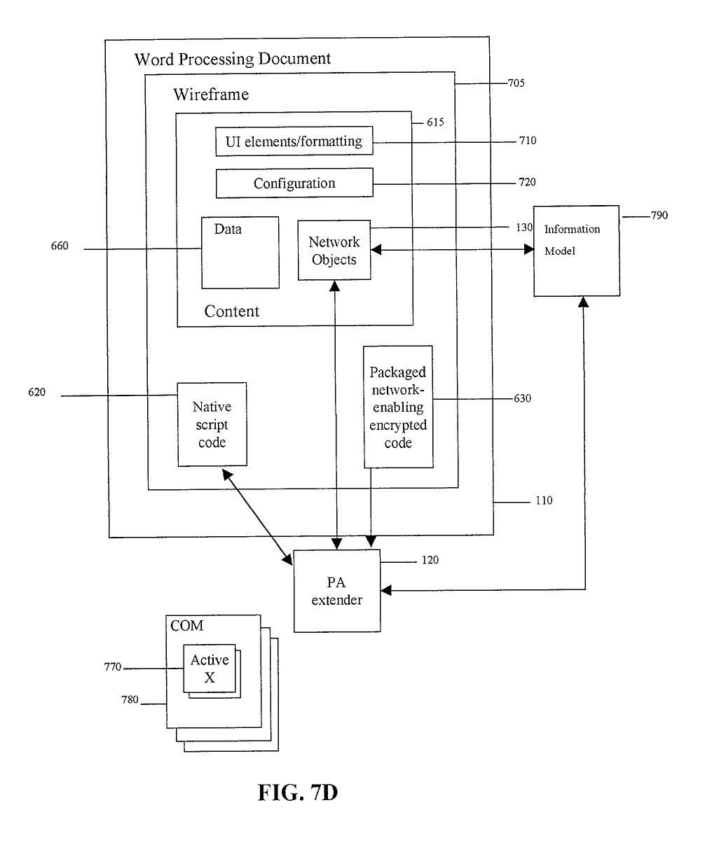

The network-enabling software 210 may further be provided with developer tools 320, which provide a plurality of functionality to a developer who wishes to create an enhanced word processing document 110. The developer tools 320 may automatically be invoked upon the launching of the productivity application 100. According to one embodiment, the developer tools 320 have a UI for display to the developer in the form of a toolbar. The developer tools 320 also allow manipulation of an information model 790 (FIG. 7D) for the productivity application 100, including handling of wireframe data, population data, and the queries used to retrieve the population data. The developer tools 320 provide software developers with the ability to construct network-enabled productivity application and create end-user tools and utilities, and network-enabling objects 130. The developed functionality may be used for various network-based capabilities. It should be noted that the functionality is developed in accordance with the information model 790 (FIG. 7D).

The developer tools 320 are configured to provide various sets of functionality, enabling a developer to build and deploy a compatible network-based spreadsheet. The functionality may include layout utilities, forms management, query management, data modeler, a packaging assistant, and other miscellaneous utilities and operations that assist in network-based activities, along with any combination of one or more of the enumerated functions.

According to one embodiment, the developer tools 320 are created and packaged as a COM component. The developer tools 320 package is deployed as a DLL file. As such, the developer tools 320 may also be used by any application running system-wide, in addition to being accessible within the underlying productivity application 100. According to another embodiment, each functionality of the developer tools 320 may be provided as a distinct COM component that can be installed by the software developers at their own wish. According to yet another embodiment, groups of functionality of the developer tools 320 may combined into single COM components that can be installed by software developers at their own wish. It should be noted that designing the developer tools 320 as a DLL file is just one method of deployment, and various other manners of deployment exist within the scope of the present invention.

The productivity application extender 120 and the developer tools 320 are integrated or coupled to the productivity application 100 through the productivity application extension enabler 260. This integration may be achieved through standard methods of extensibility. It should be noted that the productivity application 100 may make itself extensible through a variety of means. For example, Microsoft's products can be extended through what they term as an “add-in” model, where the COM object extenders, such as the developer tools 320 and the productivity application extender 120, are defined as add-ins at design time, through, for example, the use of a wizard or by implementing a required programming interface.

FIG. 3B provides an illustration of a second embodiment of the network-enabling software 210 for use by users. The network-enabling software 210 is provided with the productivity application extender 120 that provides the productivity application 100 with a plurality of network-based capabilities, as well as a plurality of user tools 330.

As noted above, the productivity application extender 120, which provides runtime support, includes network-functionality services 310 as well as application services 315. It should be noted that the productivity application extender 120 may be provided with just the network-functionality services 310 or just the application services 315 or a combination of the two. Furthermore, the scope of the present invention is not limited by the types of services included in the network-functionality services 310 and/or the application services 315.

The network-enabling software 210 may further be provided with a plurality of user tools 330. The user tools 330 provide the ability for a user to receive network-based functionality within the desired productivity application 100. The user tools 330 enable users to embed network-enabling objects 130 and functionality into their word processing documents 110 through the use of toolbars, user wizards and the like. In other words, the user tools 330 may comprise a UI that blends in with the UI 232 of the productivity application 100, wherein the users can utilize the UI of the user tools 330 to seamlessly embed the desired objects 130 for the network-based functionality in the word processing document 110.

According to one embodiment of the invention, the user tools 330 are configured to provide various optional features, such as web page scraping, embedded tables that might support, for example, stock quotes in real time, and other miscellaneous utilities and operations that assist in network-based activities within the spirit of the present invention. This includes formatting, enhancing, manipulation tools for fonts, colors, and the line. As a result, the user tools 330 enable users to embed live data feeds, create objects to send and receive e-mails, selected web pages to embed in the word processing document 110, and other similar network-based functions. The user tools 330 allow embedding of network-enabling objects 130 that use the network-functionality services 310 at runtime to achieve the network-based functionality.

As noted above, the user tools 330 often work in conjunction with the productivity application extender 120 to provide said network-based functionality.

It should be noted that the user tools 330 are intended for the end user. On the other band, the developer tools 320 are intended for the developer. The productivity application extender 120 may be utilized by both the user tools 330 as well as the developer tools 320. As such, if for example one created a set of functionality geared at lawyers, called “lawyer tools,” the lawyer tools may leverage some of the packaged functions of the productivity application extender 120 in addition to the functionality contained therein. It should be noted that all components of the network-functionality software 210 work in conjunction with the network-enabling objects 130 in the word processing document 110.

According to one embodiment, the user tools 330 are created and packaged as a COM component. The user tools 330 are deployed as one DLL file. According to another embodiment, the user tools 330 may be provided as distinct COM components that can be installed by software developers at their own wish. It should be noted that designing the user tools 330 as a DLL file is just one method of deployment, and various other manners of deployment exist within the scope of the present invention.

The present invention also provides users with the ability to incorporate extended services 340 designed by the third-party software developers. According to one embodiment, the third party developers may create network-enabling objects using the developer tools 320 (FIG. 3A). According to another embodiment, the extended services 340 may be created by any generic tool for developing COM components. The use of extended services 340 provides the flexibility of later augmenting a productivity application 100 with new network-based functionality that may be created or authored in the future, while still being designed in accordance with the information model 790 (FIG. 7D). This allows developers the opportunity to leverage the existing functionality available in the productivity application extender 120 or even the user tools 330 or developers tools 320.

The productivity application extender 120, the user tools 330 and the extended services 340 are integrated or coupled to the productivity application 100 through the productivity application extension enabler 260. This integration may be achieved through standard methods of extensibility. It should be noted that the productivity application 100 may be extended through a variety of means. For example, MICROSOFT's products can be extended through an “add-in” model, where the COM object extenders, such as the user tools 330, the extended services 340 and the productivity application extender 120, are defined as add-ins at design time, through, for example, the use of a wizard or by implementing a required programming interface.

FIG. 4 depicts one embodiment of the process for providing custom network-based functionality to a productivity application 100 from the network-enabling software 210. The COM component is installed on a PC that has the productivity application 100 running thereon, and maybe used in conjunction with the word processing document 110 opened in the productivity application 100. The COM component enables the network-enabling objects 130 to receive the network-based functionality in the opened word processing document 110.

At step 410, the custom functionality is authored, which may leverage functionality found in productivity application extender 120, the developer tools 320 and the user tools 330. There are various mechanisms to create the custom functionality, such as using Visual Basic® development language to create ActiveX® objects, programming a component in the C++ language, and the like. At step 420, the developer of the custom functionality enters certain custom registration information into the object created. The custom information may include, for example, properties such as an object's fixed name, display name, and Global Unique Identifier (GUID). This custom registration information is needed to conform the created custom functionality to work correctly with the rest of the invention's architecture. The custom registration information is used to provide a common way for all of the pieces to be able to communicate with each other. With correct registration information, a custom set of functionality can link itself to, and make use of, the productivity application extender 120. The productivity application extender 120 then becomes aware of the custom functionality and the services provided, and can manage them appropriately. It is important to conform the created custom functionality appropriately so that the productivity application extender 120 can be aware of and manage the custom functionality. In one embodiment, the custom functionality will make use of the services offered by the productivity application extender 120 as well as use the productivity application extender 120 to communicate with network-enabling objects 130 within the word processing document 110.

As shown in step 430, once the authored custom functionality has the appropriate registration information, the functionality is packaged as a DLL file with the desired configuration. Thus, if the developer wishes to deploy a plurality of DLL files in an installation program, the DLL files would be packaged together with an installation manager. It should be noted that the developer can also set other properties on the network-enabling object 130, such as threading models, debugging levels, and the like.

At step 440, the DLL for the appropriately packaged custom functionality is provided to the user. The user may obtain the custom functionality in a variety of different ways, such as in an installation disk or Compact Disk (CD), or via download from a web site. The obtained DLL for the custom functionality is installed on a computing device, as shown in step 450. The installation takes place in accordance with the developer's designed method, such as running an install program to automatically install the DLL on the computing device in the appropriate location.

At step 460, the custom DLL registers with the operating system registry, which allows the DLL to operate/function correctly under the COM architecture. For example, if the DLL is being installed on MICROSOFT, WINDOW, the DLL registers with the WINDOWS registry. The registry provides a secure, unified database that stores configuration data in a hierarchical form, which allows system administrators to easily provide local or remote support, using administrative tools. The registry also allows developers to store their own configuration data for their custom applications.

At step 470, additional information is read from the DLL by a service manager that resides in the productivity application extender 120. This is the information originally entered in step 420 by the developer, dictating the rules for the manner in which the custom functionality is to be utilized.

Finally, in step 480, the service manager of the productivity application extender 120 makes the registered DLL available to the productivity application 100. It should be noted that the DLL has the necessary properties, run-time information and other information needed. At this point, the service manager in the productivity application extender 120 knows that a new set of functionality exists and how to offer the functionality to other system components. Once the productivity application extender 120 is installed, the service manager is available.

Once the necessary productivity application extender 120 and developer tools 320 have been installed, the software developer may use these tools to author custom network-based functionality that can be made available as extended services 340.

It should also be noted that users will utilize the aforementioned process for installing the necessary user tools 330 as well as extended services 340. Once the necessary productivity application extender 120, user tools 330 as well as extended services 340 have been installed, the users may access network-based functionality in their documents 110 opened within the productivity application 100.

According to the invention, and as discussed above, two logical pieces of code are required for operation of the invention. The first piece is the embedded network-enabling objects 130 and a network-enabling code 630 (FIG. 6). The second piece is the network-enabling software 210, including the productivity application extender 120 and/or user tools 330 and/or developer tools 320. While in one embodiment, the network-enabling software 210 is an external piece of software that augments the productivity application 100, as discussed above, in another embodiment, the network-enabling software 210 can be embedded into the productivity application 100 as an integral part thereof.

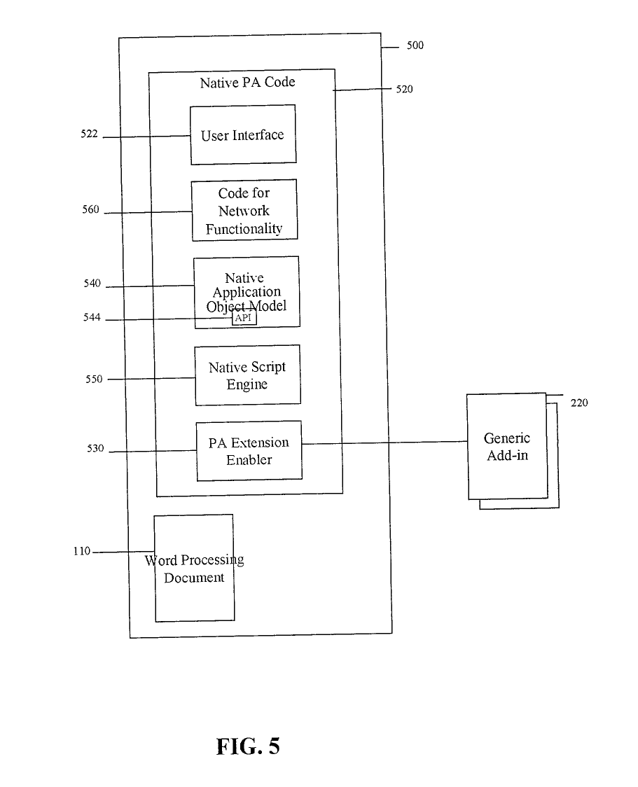

FIG. 5 provides an illustration of a productivity application 500 which is configured to provide users with network-based functionality as an integrated feature thereof, in accordance with the present invention. The productivity application 500 may be augmented by the use of one or more generic add-in(s) and/or plug-in(s) 220 that may be supplied by third-party vendors, or the like.

The productivity application 500 comprises a native productivity application code 520. The native productivity application code 520 includes code that makes the productivity application 500 operational and provides the functionality and features that are standard for the productivity application 500. The native productivity application code 520 generally comprises the code that creates and provides the UI 522 for the underlying productivity application 500.

The native productivity application code 520 may also include a productivity application extension enabler 530 which allows and facilitates the use of add-in(s) and/or plug-in(s) with the productivity application 500. The productivity application extension enabler 530 is a facility that allows generic add-in(s) to plug into the productivity application 500 for adding new functions, operations or features that were not originally available in the productivity application 500.

The native productivity application code 520 may expose a Native Application Object Model 540. The native object model 540 includes a description of an object architecture, including the details of the object structure, interfaces between objects and other object-oriented features and functions. The Native Application Object Model 540 enables the use of an add-in 220 or any other macro or extender running on the PC so that the functionality of the add-in 220 and/or other macros or extenders can seamlessly be integrated into the productivity application 500. The native productivity application code 520 may also include an API 544 to allow the productivity application 500 to interact with other programs for expanding the standard features or providing additional functionality thereto. According to one embodiment, the API 544 is an integral part of the native object model 540.

The native productivity application code 520 may provide a native script engine 550. The native script engine 550 is a facility in the productivity application 500 that executes macros or any other extenders that are to be run along with the productivity application 500.

The native productivity application code 520 is provided with code that provides network functionality. The code for network functionality 560 comprises a plurality of network-based utilities. The code for network functionality 560 may be configured to handle application services, such as XML parsing and handling, session management, security, event handling and service management, location management, query routing, document packaging, caching, data initialization and persistence, command routing and other similar functions and operations that assist in network-based activities. In addition, the network-based utilities are configured to provide various optional utilities that are used to create word processing applications 110 with network-based functionality therein. The network-based utilities may include layout utilities, forms management, query management, data modeler, packaging assistant, page scraping, stock quotes in real time, and other miscellaneous utilities and operations that assist in network-based activities within the spirit of the present invention.

Using the available features of the productivity application 500, one can create a new word processing document 110 or open an existing word processing document 110 to perform operations thereon. The code for network functionality 560 allows users to embed network-enabling objects into the word processing document 110, which will be described in greater detail below. Once the network-enabling objects are in the word processing document 110, the code for network functionality 560 allows a user to use the network-enabling objects and receive the network-based functionality in their word processing document 110, in addition to the non-network functionality and features provided by the productivity application 500.

FIG. 6 provides an illustration of one embodiment of a word processing document 110 in accordance with the present invention. The word processing document 110 comprises document code 610 and content 615. The document code 610 includes all computer-readable instructions necessary to provide the word processing document 110 with its look and feel, as well as provide support for any functionality embedded in the word processing document 110.

The document code 610 includes a script code 620. The script code allows users or developers to extend the built-in functionality of the productivity application 500 or simply create macros containing often-used packaged sequences of operations (for example, repeatedly creating the same customized chart from a set of data). The script code 620 also may provide the ability to interact with ActiveX® controls and other COM components on the computing device to utilize their provided functionality within the word processing document 110.

The document code 610 may further include network-enabling code 630 for providing network-based functionality within the word processing document 110 at launch-time by initializing and launching the network-enabling object 130 to provide network-based functionality. According to one embodiment, the network-enabling code 630 is unpacked and read by the productivity application extender 120 at launch-time, and after that the network-enabling code 130 is not used, accessed, and/or read during run-time. In other words, during run-time of the network-based functionality, the network-enabling code 630 plays no role, and is akin to not being present. The network-enabling code 630 is unpacked (i.e., read) at load/launch time by the productivity application extender 120 to support the functionality of the productivity application extender 120.

The network-enabling code 630 contains computer readable instructions for allowing the initialization and/or launch of the network-based functionality as well as any other functions within the scope of the present invention. According to one embodiment, the network-enabling code 630 may include a plurality of routines to provide different operations and functionality. According to another embodiment, the network-enabling code 630 may be a plurality of distinct modules, separately packaged in the document code 610. The network-enabling code 630 may be programmed to include support for query instructions, layout instructions, data modeling, and various other features that may augment the word processing document 110 with additional network-based functionality.

According to one embodiment, the network-enabling code 630 is packed together in a secure location within the document code 610 of the word processing document 110. In the event that the network-enabling code 630 is packed, it must be unpacked prior to use of network-enabling code 630 for providing network-based functionality. Furthermore, the network-enabling code 630 may be encrypted with a suitable encryption algorithm to ensure that the network-enabling code 630 is tamper-proof, as well as to restrict utilization of the underlying network-based functionality to the appropriately registered modules. According to one embodiment, the network-enabling code 630 is packed for storage and/or transmission over a network or the Internet.

It should be noted that when the word processing document 110 with network-based functionality is stored and/or uploaded, the word processing document 110 can have a mix of packed and unpacked network-enabling code 630. The packed portion of the network-enabling code 630 requires unpacking prior to run-time of the network-based functionality.

The content 615 in the word processing document 110 includes data 660 and network-enabling object(s) 130. The data 660 may include static data 670 as well as dynamic data 680. Static data 670, once entered, maintains its state and is often only altered by a user. Dynamic data 680, on the other hand, may be added and/or altered at any time, possibly without any active intervention by a user. For example, the word processing document 110 could be configured for allowing the dynamic data 680 to be altered in real-time by content from the Internet or other networks by providing a real-time feed into the word processing document 110.

It should be noted that according to one embodiment, the content 615 may also be provided as a mix of packed and unpacked content in addition to the network-enabling code 630. For example, where it is desired that the user not be able to access certain pieces of content, the content may in fact not get completely unpacked at runtime. Similarly, it is possible to not unpack part of the network-enabling code 630 to deprive an unlicensed user of its functionality, and the still-packed code 630 would be inert and not executable at runtime. Additionally, it is possible to pack the content 615 in an encrypted format.

The network-enabling object 130 may be embedded as part of the content 615 of the word processing document 110. As part of the invention's distributed architecture, the network-enabling object 130 may be able to communicate with the script code 620. Through the script code 620, the network-enabling object 130 may communicate with the productivity application extender 120, and the productivity application extender 120 then communicates with the network-enabling code 630. It should be noted, that the network-enabling object 130 is also capable of interacting directly with the productivity application extender 120.

According to one embodiment, the network-enabling object 130 may be a self-contained packaged set of functionality. According to another embodiment, the network-enabling object 130 will operate in conjunction with the productivity application extender 120 and other custom functionality that persists on the client, such as user tools 330, developer tools 320 and/or other add-ins.

According to the invention, the developer may leverage the distributed architecture and decide how “heavy” to make the network-enabling object 130 portion of the code, by providing all the requisite code for receiving network-based functionality as part of the network-enabling object 130. The developer can decide the amount of functionality to be put into the network-enabling object 130, versus putting the network-based functionality as a custom add-in. The best balance will depend on the particular functionality being deployed, and perhaps even on deployment issues such as code size for add-in code being downloaded from the Internet for installing on the client.

FIGS. 7A-7D provide an illustration of different states of communication between the word processing document 110 with one or more controls external thereto. According to an embodiment of the present invention, the word processing document 110 comprises a wire-frame 705, which has content 615, native script code 620 and network-enabling code 630. The content 615 comprises user interface (UI) 710, which has information regarding formatting and layout for the data 660 and the objects 130 therein. The UI 710 essentially provides the look and the feel of the content 615. For example, the UI 710 controls the fonts, formatting and the layout of text in the word processing document 110. The content 615 further includes configuration 720, which enables and facilitates the user's viewing thereof. For example, the configuration 720 may allow a user to decide the zoom-in level of the word processing document.

As noted above, the content 615 includes static and/or dynamic data, depending on the choice of the user. In addition, the content 615 may be provided with network-enabling objects 130 for launching network-based functionality from within the world processing document 110. Non-network-based content, such as typical textual and/or graphical content of a word processing application, may also be included.

According to the invention, the native script code 620 provides the ability to interact with ACTIVE X controls and other COM components on the computing device to utilize the network-based functionality within the word processing document 110. The native script code 620 permits the productivity application 100 to leverage its core functionality and permits the productivity application 100 to provide network-based functionality from within the productivity application 100 environment. While there are various network-based functionality that can be provided, they may include communications services that allow a user to communicate and interact with others, streaming services that allow a user to receive and play streaming content, data services that allow a user to retrieve, manipulate, and view data retrieved over a network, as well as various other services within the scope of the present invention.

According to one embodiment of the present invention, the native script code 620 allows any of the network-enabling objects 130 in the word processing document 110 to interact with the productivity application extender 120 running alongside the productivity application 100. More particularly, external components communicate with the network-enabling objects 130 via the productivity application extender 120. While this is one mechanism of operation, it should be noted that the present invention also allows the productivity application extender 120 to directly communicate with the network-enabling objects 130, without requiring any intervention from the native script code 620, according to another embodiment of the present invention.

The network-enabling code 630 facilitates the providing of network-based functionality within a word processing document 110. The network-enabling code 630 contains computer readable instructions for launching network-based functionality as well as any other functions within the scope of the present invention. The network-enabling code 630 may be programmed to include support for query instructions, layout instructions, data modeling, and various other features that may augment the word processing document 110 with additional network-based functionality. As noted above, the network-enabling code 630 may be packed in a secure location within the word processing document 110, in which case it must be unpacked prior to its use. Furthermore, the network-enabling code 630 may be encrypted.

According to the invention, the native script code 620 is capable of communicating with the productivity application extender 120 or other external COM components 780 or ACTIVE X controls 770. According to the invention, there are different models according to which the network-enabling objects 130 may interact with the productivity application extender 120 to provide network-based functionality, as shown in FIGS. 7A-7D. Accordingly, a developer may extend and customize the productivity application extender 120 in a variety of ways to provide any additional type of customized functionality.

When designing additional ActiveX 770 and/or COM controls 780, the developer can have them work in conjunction with network-enabling objects 130, allowing the productivity application 100 to become a distributed application. The developer has the flexibility to design and provide network-based functionality in different ways, since they can utilize the productivity application extender 120, or they can provide the network-based functionality via the native script code 620. According to one embodiment, a part of the distributed productivity application manifests itself as the network-enabling object 130 and another part takes the form of an ACTIVE X control 770. According to another embodiment, another part of the distributed productivity application could be a COM control 780 that leverages functionality available in the productivity application extender 120.

FIG. 7A provides an illustration of the present invention at launch-time of the network-based functionality. Initially, network-based functionality is launched when the productivity application extender 120 reaches into the word processing document 110 and unpacks (i.e., reads) the network-enabling code 630. The information from the network-enabling code 630 is stored in the productivity application extender 120 which allows it to provide the appropriate network-based functionality at runtime. It should be noted that the productivity application extender 120 is not supported by the other external COM components 780 or ACTIVE X controls 770, initially. Furthermore, in this embodiment, the productivity application extender 120 does not need to communicate with the native script code 620 to unpack the network-enabling code 630.

As shown in FIG. 7B, according to one embodiment, the network-enabling object 130 communicates with the productivity application extender 120 to provide network-based functionality in the word processing document 110. According to this embodiment, the network-enabling object 130 is provided with the necessary code to interact with the productivity application extender 120 to launch, obtain and utilize the network-based functionality within the word processing document 110. It is possible for the productivity application extender 120 to interact with the COM component(s) 780 to seek additional functionality not available in the productivity application extender 120, as indicated by the instructions contained in the network objects code. It should be noted that the network-enabling code 630 play no role in the process. According to this embodiment, the native script code 620 is not necessary for providing the network-based functionality.

As shown in FIG. 7C, according to another embodiment, the productivity application extender 120 communicates with the network-enabling object 130 to provide network-based functionality in the word processing document 110. Furthermore, the productivity application extender 120 may interact with the COM component(s) 780 to seek additional functionality not available in the productivity application extender 120. Based on the operations and features of the productivity application extender 120 and/or the COM components 780, the native script code 620 may be provided with the requisite information to allow it to communicate with the network-enabling objects 130. According to one embodiment, the native script code 620 can communicate directly with the ACTIVE X 770 and/or COM controls 780 to provide additional functionality not available through the productivity application extender 120. As a result, the network-enabling objects 130 may provide network-based functionality in accordance with the productivity application extender 120 as well as the ActiveX 770 and/or COM controls 780.

As shown in FIG. 7D, according to another embodiment, the network-enabling object 130 communicates with the productivity application extender 120 to provide network-based functionality in the word processing document 110. Furthermore, the information from the unpacked network-enabling code 630 that is read by the productivity application extender 120 provides the requisite information to the native script code 620, and creates and provides the necessary information to an information model 790. Where the network-enabling code 630 is provided packed, the productivity application extender 120 unpacks the network-enabling code 630 prior to launch to read the necessary information therefrom and create the information model 790. The information model 790 is a holding area that houses information about the functions the word processing document 110 is supposed to support at runtime, and the methodology for running the functions. For example, the information model 790 might contain a query definition of how to retrieve stock quote information, namely the server to look for, the data parameters to retrieve, and the mechanism for handling the resulting data sets.

The information model 790 interacts with the network-enabling objects 130 to provide the appropriate network-based functionality within the word processing document 110.

Since network-based functionality may be distributed between network object 130 and COM component 780, the desired network-based functionality can be authored by a developer according to the best suited structure. A developer may choose to place more functionality in COM component 780, resulting in a “lightweight” network-enabling object 130. This allows easier distribution of the word processing document 110 once the base COM component 780 has been installed.

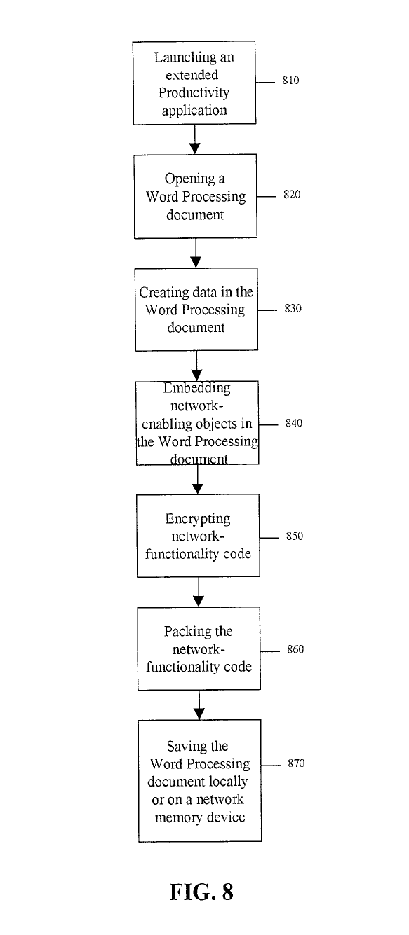

FIG. 8 is a schematic flow diagram depicting the process for creating a word processing document with network-enabling objects embedded therein. In general, the objects 130 may be embedded into word processing document 110 in several ways. They can be placed into documents by developers, and the documents can then be posted on a web site or e-mailed to users. When coupled with the ability to control and manage the behavior of the containing application, this basically provides for the development of powerful, distributed “embedded applications” that are essentially defined by the combination of the productivity application and the enhanced word processing document 110 within it. Alternatively, the network-enabling objects 130 can be made available to users and stored on user systems. Users can then place objects personally into individual word processing documents 110 they create or receive. This capability can be used in combination with other Internet or network functions.

The present invention may also be used to provide professional developers with a tool set for creating productivity application based services and applications, such as “Productivity Application Web Sites.” While certain development capabilities may best be provided through a specific, separate application program for developers using the technology, many capabilities may be provided to developers through an extended version of the target productivity application itself. Thus, for example, this will allow a high fraction of web site development to be conducted using the familiar, functionally rich, and domain-specific environment of a productivity application rather than traditional web site development tools or lower level development environments such as C or Java. This will facilitate the workflow processes associated with web site development, by permitting partially completed productivity application -based web sites to be e-mailed, viewed, and edited by multiple developers and users, using augmented versions of a single productivity application. Moreover, where business rules can be defined using the built-in script and/or native functionality of the document and desktop application, parts of the productivity application-based web site can essentially be coded directly by domain experts (i.e., users) rather than passing specifications off to a developer for implementation, thereby potentially reducing development time and cost.

Referring to FIG. 8, at step 810, the productivity application 100 is launched, along with the network-enabling software 210. According to one embodiment, because of the appropriate configuration of the network-enabling software 210, it automatically launches when the productivity application 100 is launched. At step 820, the word processing document 110 is opened. According to the invention, the word processing document 110 may be new and completely blank, initialized through a pre-defined template, or a pre-existing document.

Once the word processing document 110 is open, data may be created therein, as shown in step 830. For example, content for a word processing document may be entered by the user. As noted above, the data may be static or dynamic. In step 840, network-enabling objects 130 are embedded as part of the content 615 of the word processing document 110. There are a variety of ways in which users may be allowed to embed the network-enabling objects 130 in the word processing document 110. According to one embodiment, the user is provided a toolbar as the UI of the network-enabling software 210, from which the user can simply choose the desired network-enabling object 130, and then drag and drop in the appropriate location of the word processing document 110.

As one embodiment, the system allows a user to encrypt the network-enabling code 630, in step 850. In step 860, the network-enabling code 630, which may or may not be encrypted, is placed in the document code 610 area of the word processing document 110. According to one embodiment, the network-enabling code 630 may be packed in a hidden area so that it is invisible to the user. According to another embodiment, the network-enabling code 630 may be compressed before being placed in the document code 610 area of the word processing document 110.

Finally, in step 870, the word processing document 110 is saved on the local system or networked memory device. As the above discussion shows, the saved word processing document 110 comprises data as well as network-enabling objects 130 and network-enabling code 630. During runtime, the network-enabling objects 130 and the native productivity application code 230 interact with the network-functionality software 210 to provide network-based functionality in the word processing document 110.

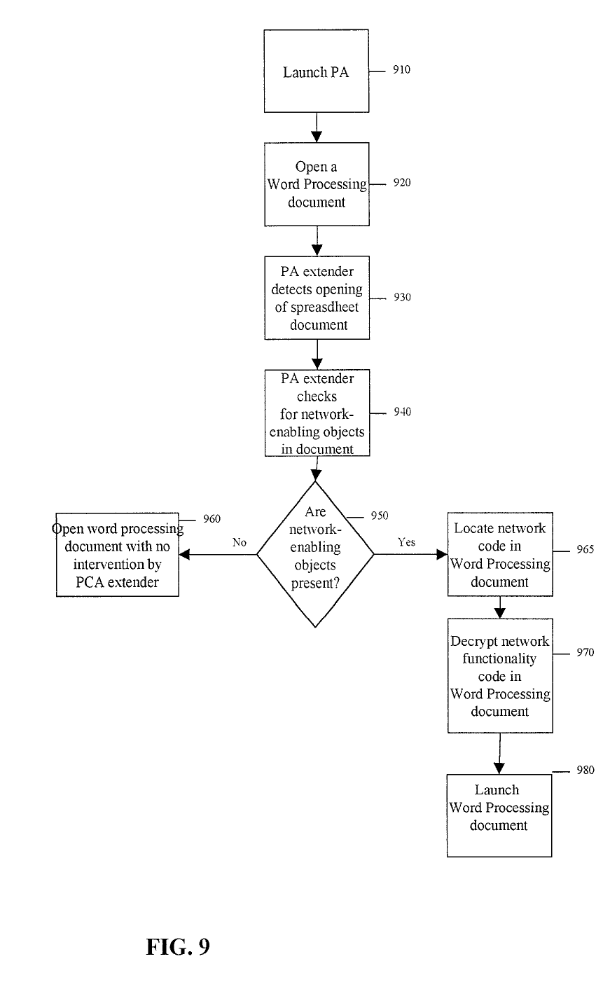

FIG. 9 provides one embodiment of the process for loading the word processing document 110 with network-based functionality therein. At step 910, the productivity application 100 is launched by a user. As depicted in box 920, once the productivity application 100 has been launched, the user opens a standard word processing document 110 for the launched productivity application 100. For example, if the launched productivity application is MICROSOFT WORD, then the open document will be a WORD-based word processing document or any other compatible WORD file type. Alternatively, the word processing document 110 may include an embedded document from the same or another productivity application, such as a WORD document with an embedded EXCEL spreadsheet.

At step 930, the installed productivity application extender 120 detects the opening of the word processing document 110. At step 940, the installed productivity application extender 120 inspects to determine if the word processing document 110 has the appropriate network-enabling objects 130 and the network-enabling code 630 therein for providing network-based functionality within. At step 950, based on the inspection in step 940, the system determines whether the word processing document 110 has the appropriate network-based functionality therein. If the system determines that the launched word processing document 110 does not have the requisite network-based functionality, then the word processing document 110 is opened with no intervention from the productivity application extender 120, as shown in step 960.

On the other hand, if the system determines that the launched word processing document 110 has the requisite network-based functionality therein, then the network-enabling code 630 is located by the productivity application extender 120 in step 965. If the network-enabling code 630 is encrypted, then the productivity application extender 120 causes decryption of the network-enabling code 630 to read it, as shown in step 970. At step 980, the system initializes and launches the word processing document 110 along with the network-based functionality in accordance with the activation of the network-enabling objects 130 and/or the instructions provided in the network-enabling code 630.

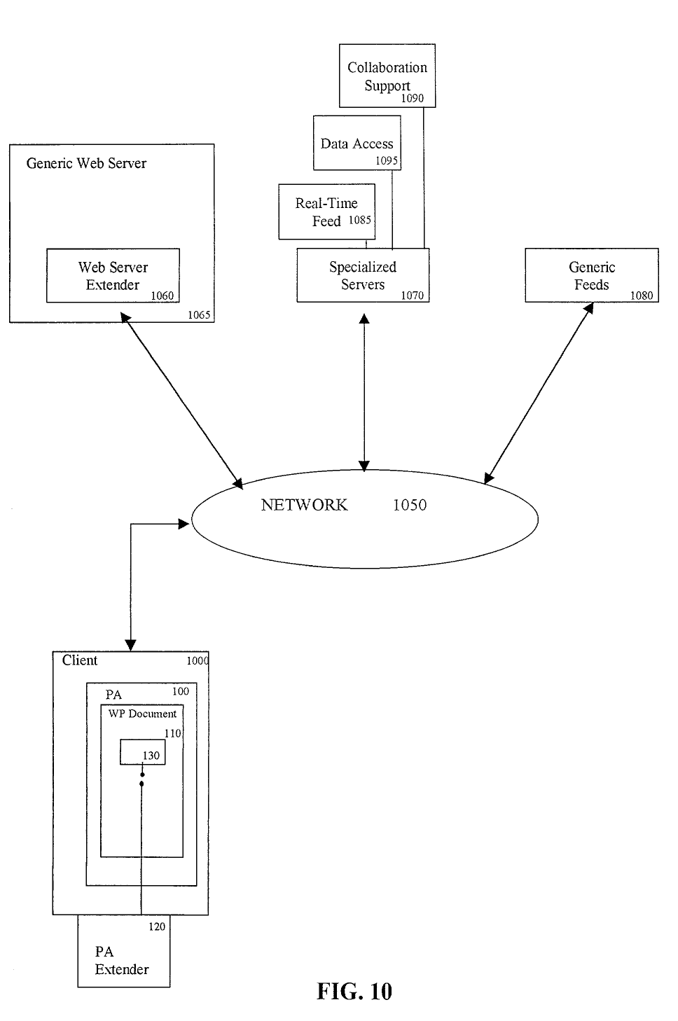

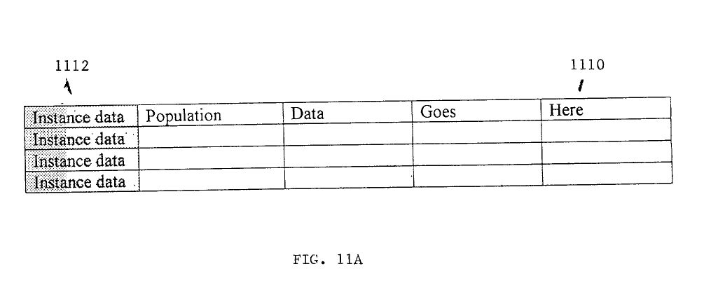

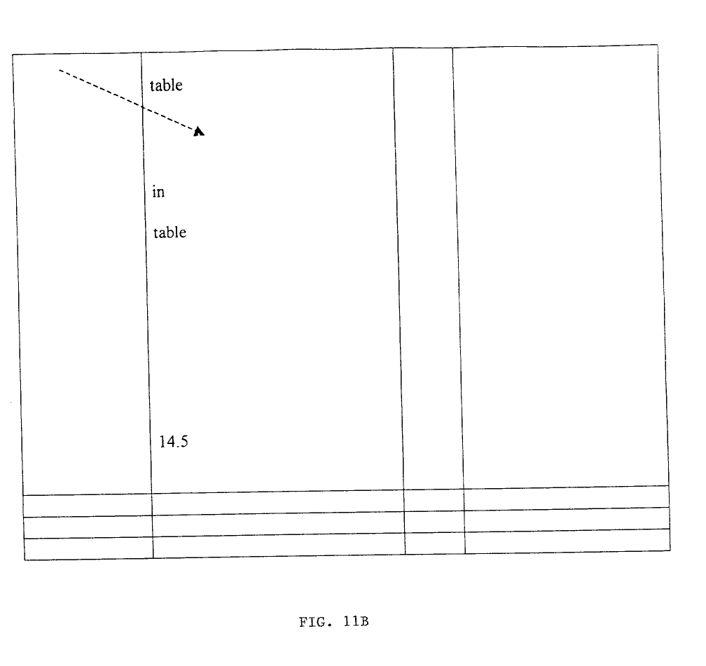

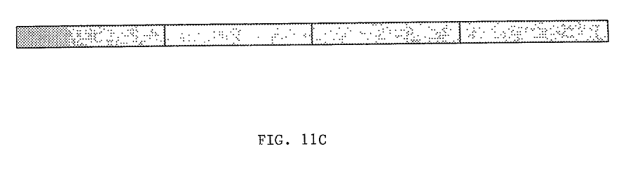

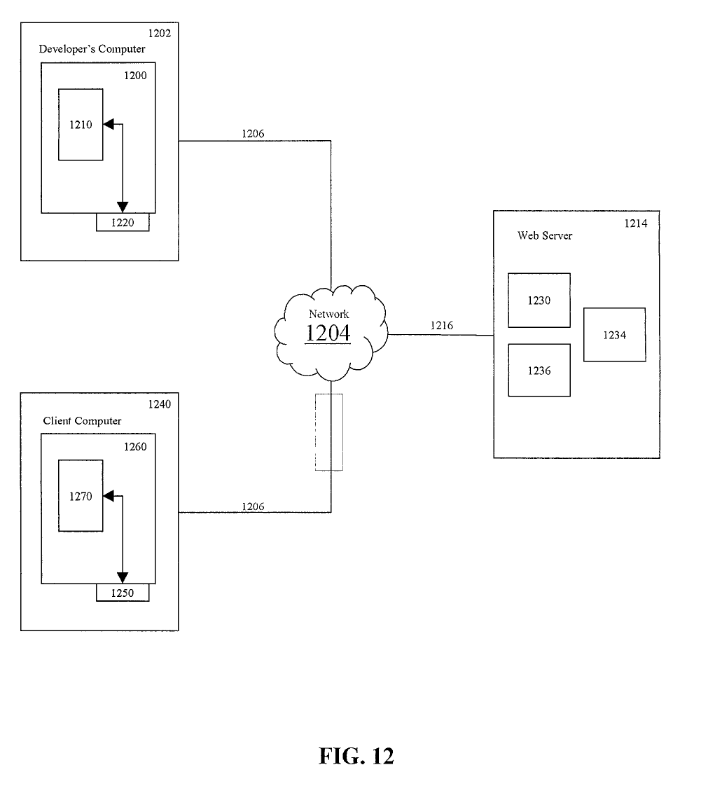

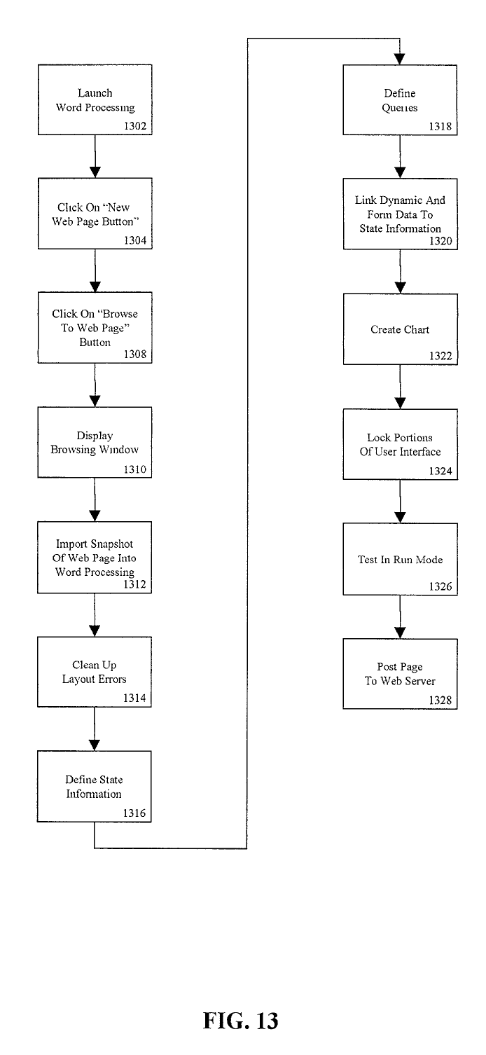

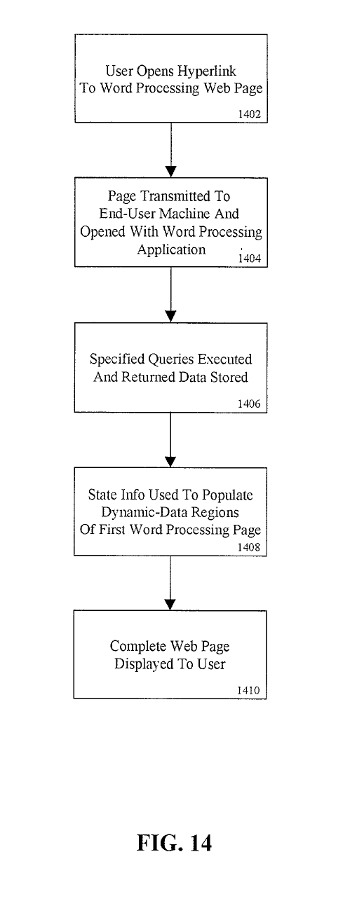

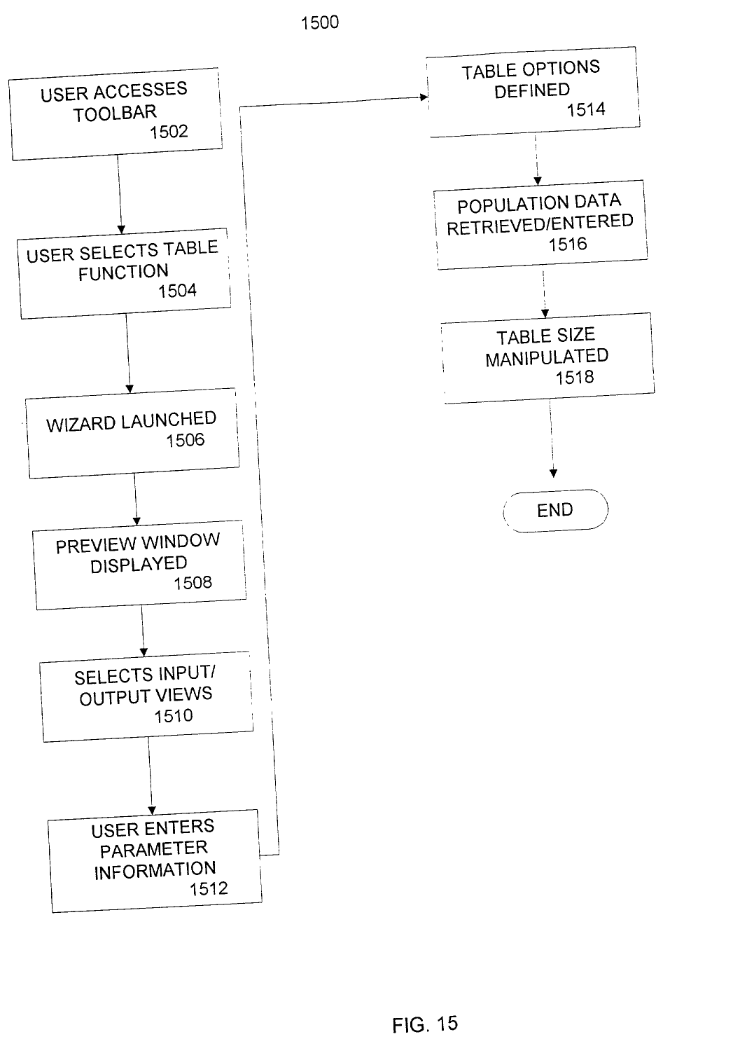

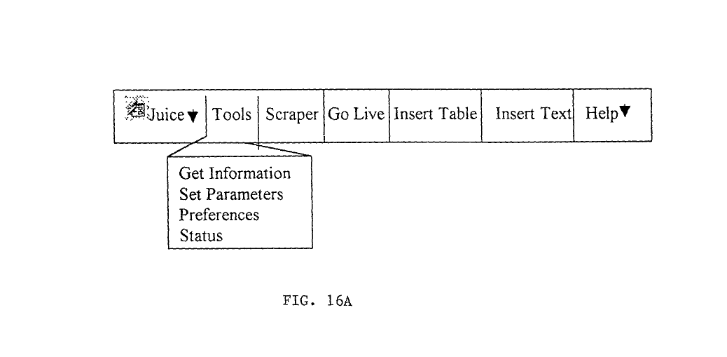

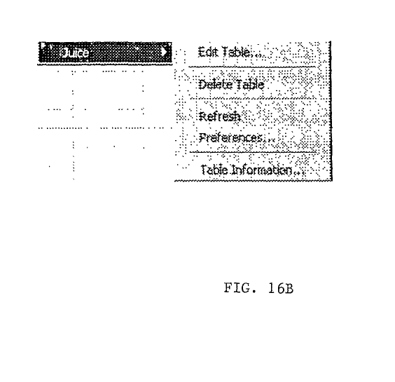

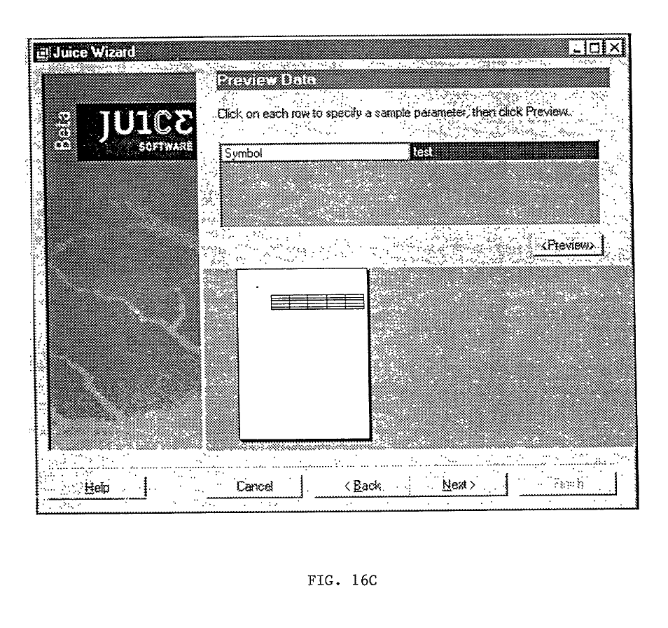

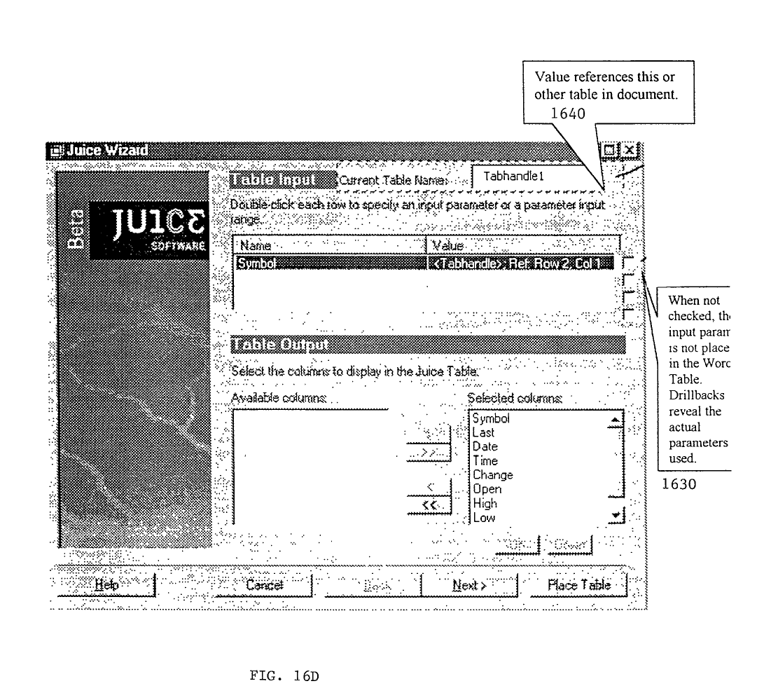

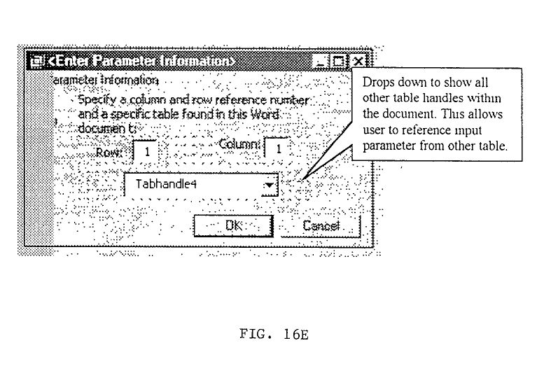

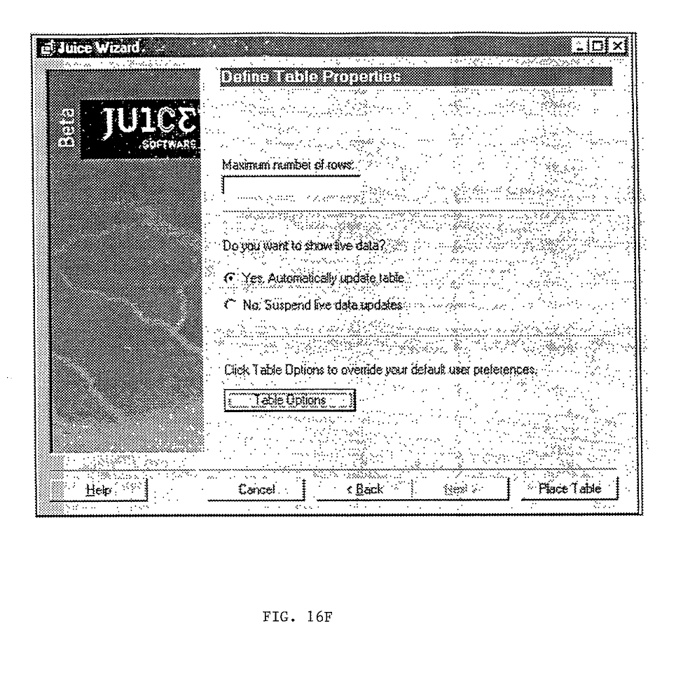

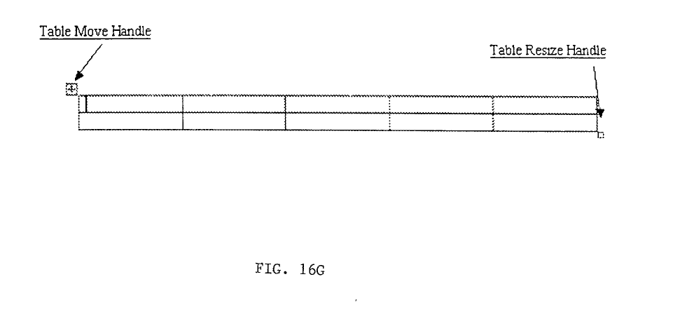

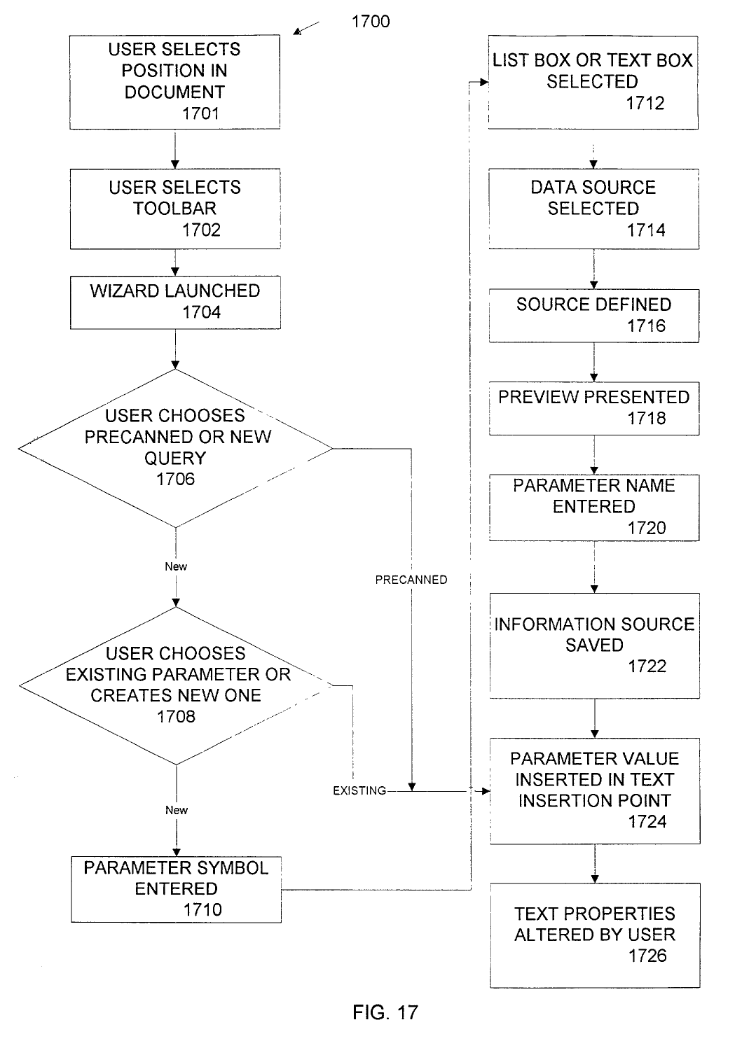

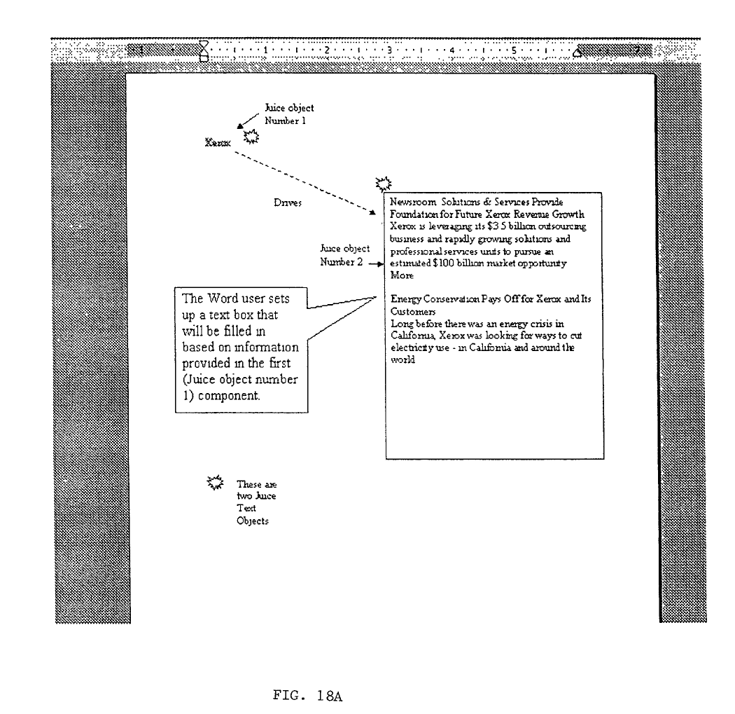

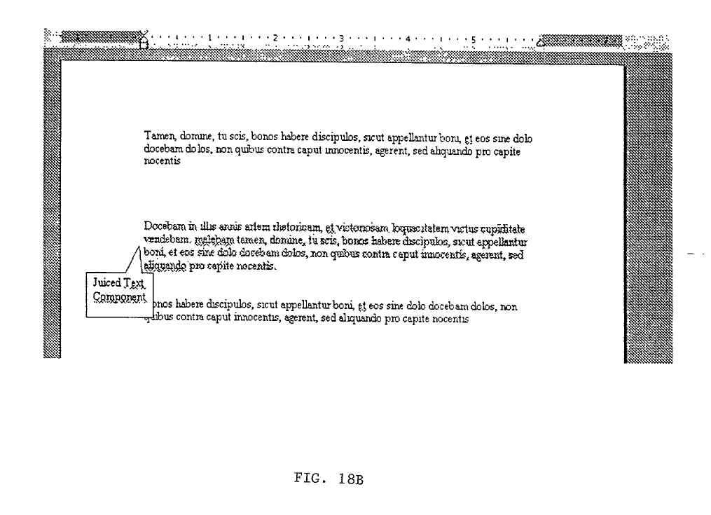

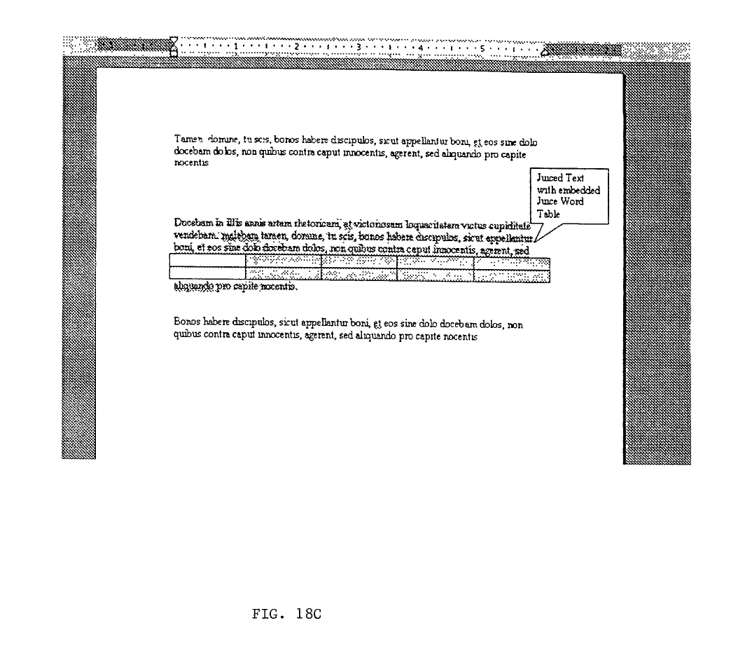

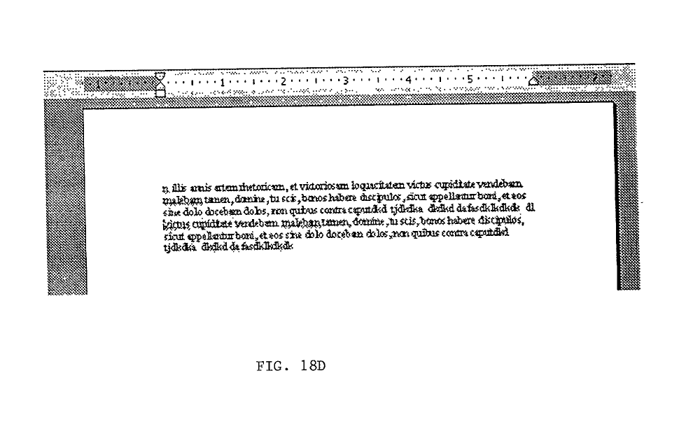

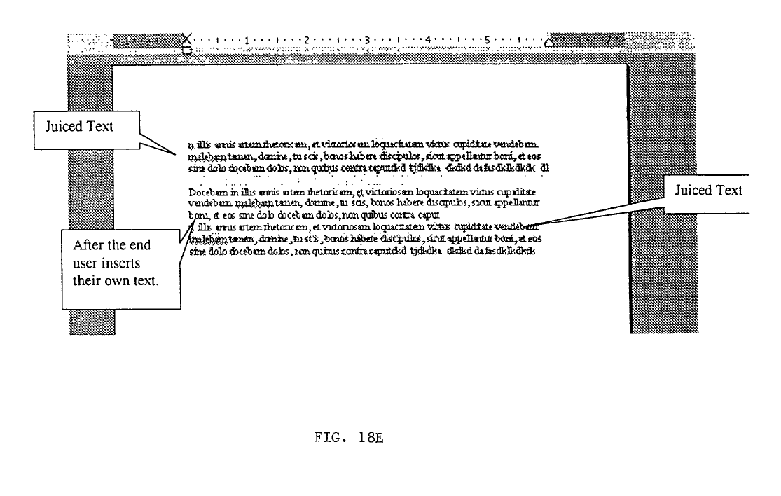

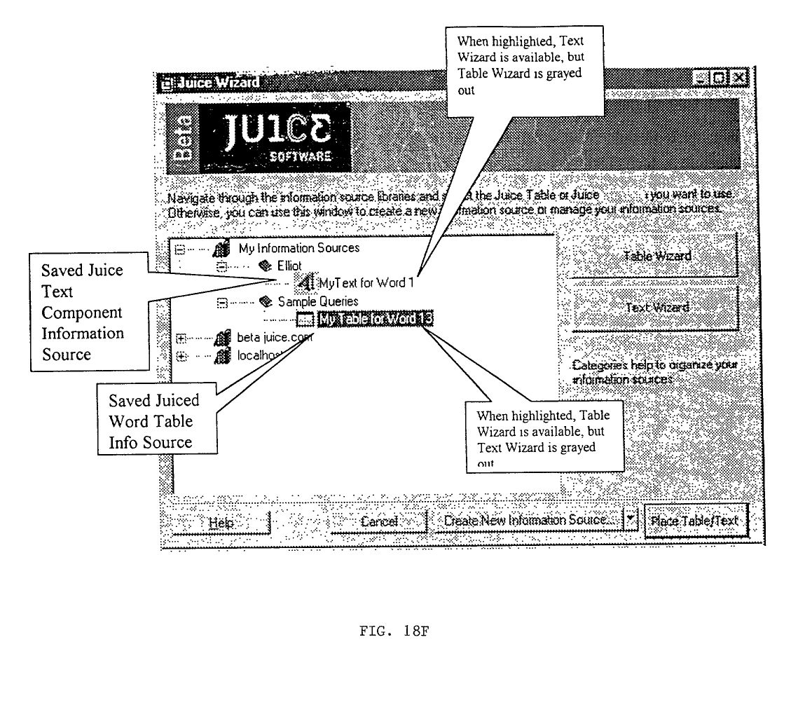

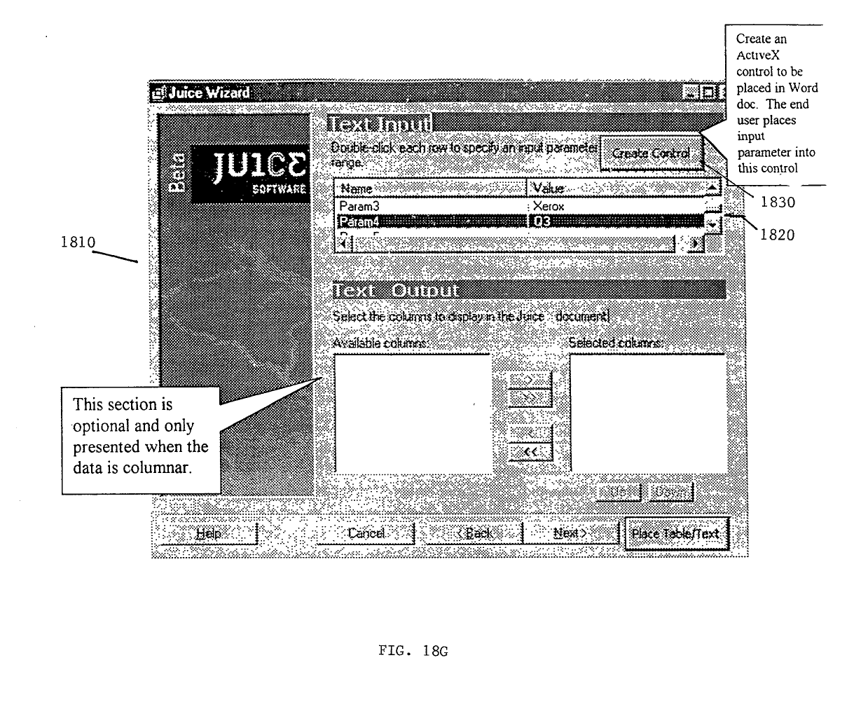

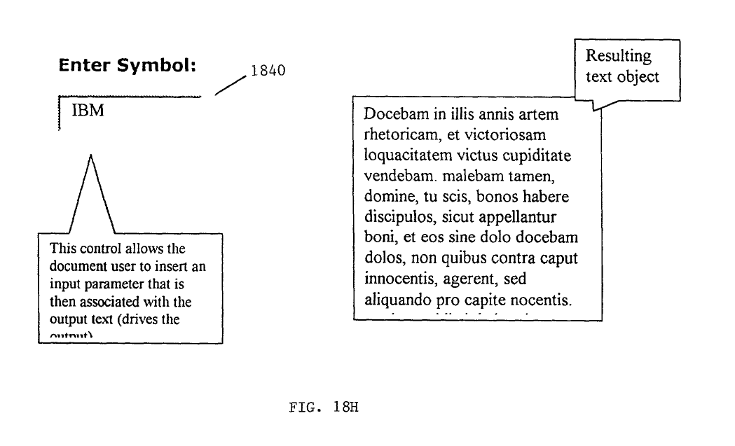

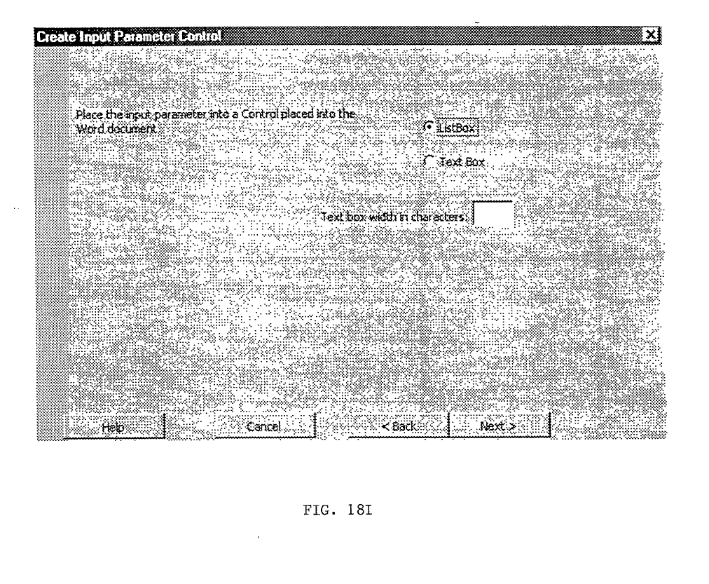

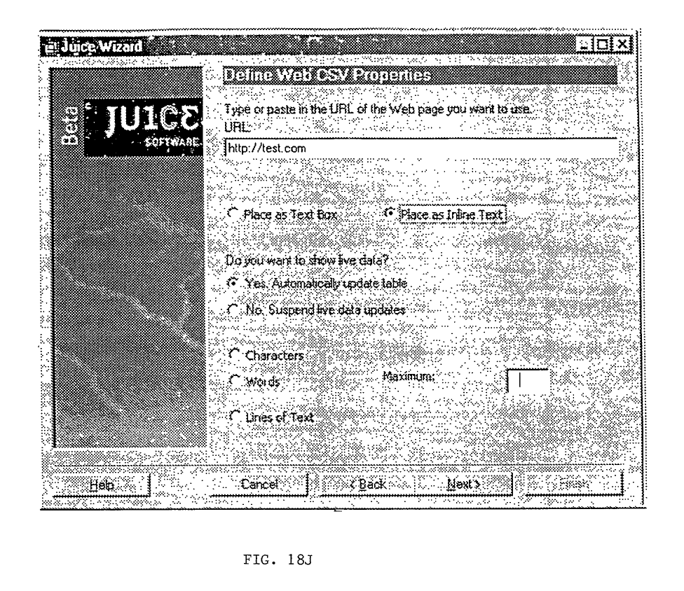

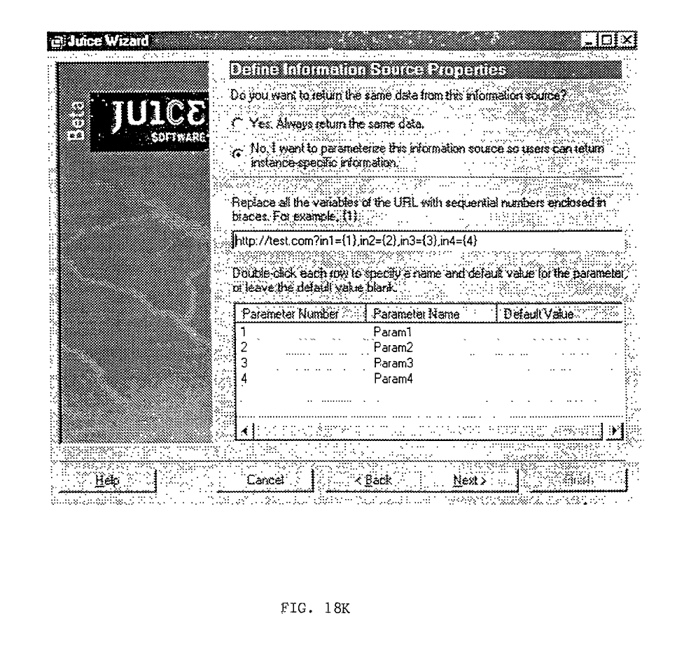

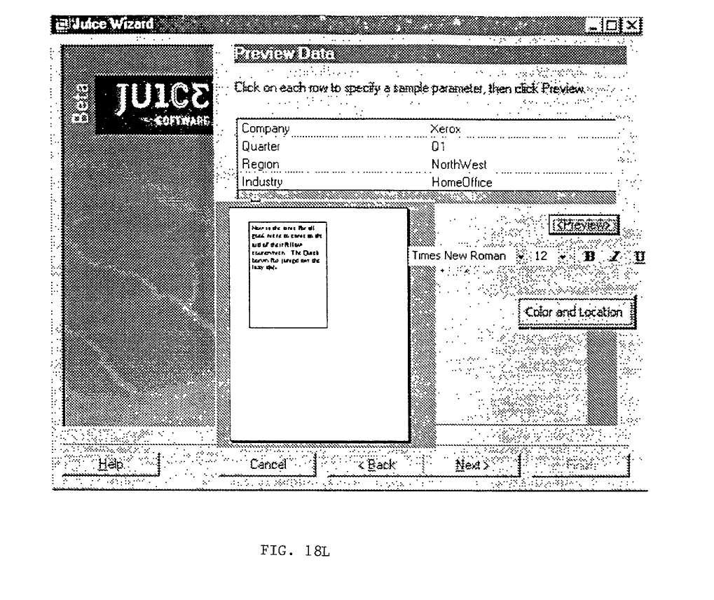

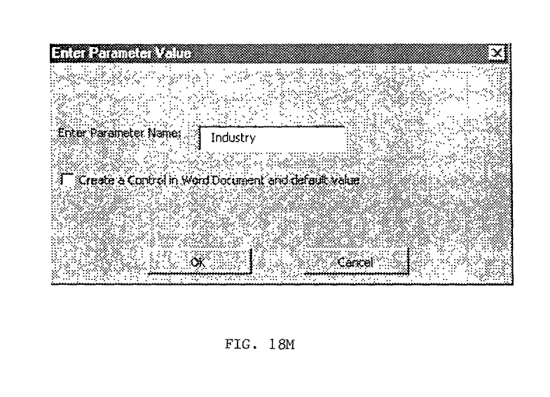

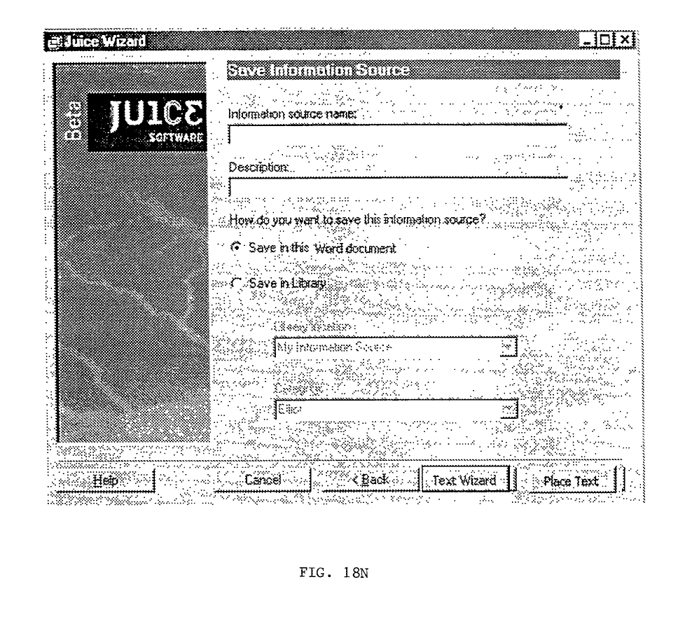

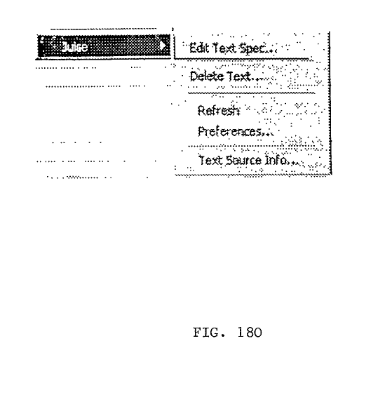

FIG. 10 provides an exemplary illustration of a client/server architecture utilizing the network-enabling features provided to the client, in accordance with the present invention. A client 1000 hosts the underlying productivity application 100. The word processing document 110 is launched within the productivity application 100. As noted above, the word processing document 110 is provided with one or more network-enabling objects 130, which communicate with the productivity application extender 120 running with the productivity application 100.

The client connects to a network 1050 for receiving the network-based functionality for which the network-enabling objects 130 are configured. Using the network 1050, the client 1000 may connect with one or more network servers, such as a web server extender 1060 which runs on a generic web server 1065, or a specialized server(s) 1070 and/or one or more generic third-party servers 1080 for real-time feeds. In one implementation, the client 1000 may be provided with one or more communication means for connecting and interacting with the network 1050. The communication means is coupled to a central processor on the client machine. The scope of the present invention is not limited by the choice of communication means employed. Accordingly, it is possible to use one or more modems, a Digital Subscribe Line (DSL), an integrated Service Digital Network (ISDN) line, a cable modem or any similar device to connect to the server and communicate therewith.

The clients are able to connect to one or more of such the server, and receive network-based functionality. For example, a client 1000 may connect to a web server extender 1060 which connects to a generic web server 1065 for receiving regular feeds about fluctuations in the stock market. The client 1000 may further connect to the specialized server(s) 1070 that provide additional specialized services to the client, such as real-time feeds 1085, collaboration support 1090, and data access 1095 and the like. Workflow servers, licensing servers and the like may also be included within specialized servers 1070. The client 1000 may also connect to other generic third-party servers 1080 for real-time feeds in any of these cases. The client system 1000 is provided with specialized network-based functionality in the word processing document 110 that allows the extended productivity application 100 to utilize the real-time feeds within the word processing document 110.

It should be noted that the client/server architecture of FIG. 10 can be utilized to download individually or collectively the productivity application 100, the word processing document 110, network-enabling software 210, and/or the network-enabling object 130 from the Internet or some other compatible network. For example, a request for a download may be received at the web server extender 1060 which appropriately transmits it to the web server 1065, or the request may be received at the specialized server(s) 1070. Accordingly, the client may transmit a login request, and then make a request to download the desired component(s) of the present invention. The request is appropriately handled at the receiving server, and the request is processed by the server. Finally, the server serves the requested component(s) of the present invention to the remote client. According to one embodiment, the client may be required to authenticate its identity prior to the server serving the requested component.

The web server extender 1060 may be utilized for custom request handling of client requests. According to one embodiment, the custom request handling may be authenticating the remote client. According to another embodiment, the custom request handling may be deciding the version of the requested component(s) to be served to the remote client.

For example, web server extender 1060 may provide intelligence to determine appropriate version of a financial data sheet to return to a client—either a productivity application spreadsheet for embedding within the word processing document, a word processing document for embedding within the current word processing document . . . or an HTML web page version.

FIGS. 11A-11C provide an illustration of the present invention where word processing documents are provided with network-based functionality included within tables therein. It should be noted that the word processing documents described in FIGS. 11A-11C are merely alternate embodiments of the present invention, and various other embodiments may be constructed using the disclosed invention.

As shown in FIG. 11A, the word processing document may include a table 1100 having one or more cells 1112 for storing instance data and one or more cells 1114 for storing population data. To accomplish this, the word processing document comprises a wireframe that may include static content and native script code that is generally not modified during runtime within a productivity application residing on an end-user's system.

Population data is dynamically generated data used to populate specified areas within a wireframe during the productivity application's runtime. Generally, population data is supplied by a server and is designated “read only” and is not altered. Population data may be used to populate fields, strings, and pick lists for display to the user, or transparently as calculation data operated on by the application. Population data may also be defined to be a function of information maintained in the associated wireframe, user input, or both, and may typically be generated or retrieved upon actions such as startup, connection, form submission, or in real-time in response to remote data changes.

Instance data is data that is specified or manipulated at the client computer by users during runtime for the eventual purpose of transmission to a server. Instance data is usually one-way data transmitted from client to server. But in some circumstances it may be desirable to read such data from a server (for example, as cached prior information to pre-populate a user form or as smart defaults for a user form) to pre-fill forms within a wireframe.

Instance data includes data items, such as data entered into text box prompts (for example, asking for a user's username and password for authentication) and parameterized data entered into defined queries (such as stock ticker symbol as a parameter in a web query).

According to FIG. 11B, the table 1110 may be a nested table wherein population or instance data from one table can be used or inserted into a second table. Each table in a word processing document (or separate word processing documents) may be assigned a table “handle” or designation which uniquely identifies the table to the network functionality code. Through such functionality, such separately designated tables may then refer to the other or a portion of the other. These two tables may also be combined to form a nested table where, for example, the contents of one table are embedded in a second table.

As shown in FIG. 11C, it is possible to have a table 1110 which displays only population data, wherein the instance data is hidden from the display. The instance data may be revealed to a user by selecting table properties from a menu or toolbar provided in the productivity application (see FIG. 16A below). The table properties may list all input parameters in the selected table whether or not such input parameters are displayed in the table.

FIG. 12-14 illustrate one exemplary embodiment for a system and method for both developing and accessing a web page as an embedded application that can be produced using an augmented spreadsheet program and an enhanced spreadsheet document. An example of such an enhanced spreadsheet in provided in FIG. 11B.

FIG. 12 is an illustration of a client/server architecture in accordance with one exemplary embodiment of the present invention, which provides a system and method for both developing and accessing a web page as an embedded application that is produced using the word processing productivity application 1200 that has been extended with a network-functionality software 1220 and a network-enabled word processing document 1210. The embedded application web page allows an end-user to enter, for example, a stock's symbol, receive relevant historical data relating to the stock via a web server, and chart the received data within the embedded application web page using the built-in charting facilities of the host word processing productivity application 1200.

The developer's system comprises a developer client computer 1202 that is connected to network 1204 via a communication link 1206. Network 1204 may, for example, be a private intranet, a virtual private network, or the global Internet, and the communication protocol used on the network may be TCP/IP or any protocol layered on top of IP, such as SMTP, FTP, HTTP, etc. In this example, the developer client computer 1202 is provided with a word processing productivity application 1200, such as MICROSOFT WORD, MICROSOFT WORDPAD or COREL WORDPERFECT. The client computer 1202 is also preferably provided with a developer's network-functionality software 1220 that adds tools and/or provides functionality to the word processing productivity application 1200 to facilitate the creation of spreadsheet web pages, and an end-user's network-functionality software 1250 for providing runtime support for the network-based functionality within the word processing documents.

The developer is connected to a web server 1214 via the network 1204. The web server 1214 is connected to the network 1204 via a communication link 1216. Web server 1214 provides access via said network 1204 to one or more web pages 1234 or customized embedded application web pages 1236. The original word processing document is now a custom embedded application 1236. Web pages 1234 or customized embedded application web pages 1236 can be stored locally or any place on any network that the web server 1214 can access.

The end-user's system comprises a client computer 1240 that is connected to the network 1204 via a communication link 1206. The client computer 1240 is provided with end-user's network-functionality software 1250, which may include user tools and a productivity application extender.

It should be noted that the developer is provided with tools that may be distinct from those provided to a end-user, because the developer uses the system to create an embedded application web page 1236, while the end-user uses the system to access and interact with that embedded application web page 1236.

In summary, the present system and method relates to a developer at client computer 1202, who identifies an HTML page 1234 to be rendered as an embedded application web page. The developer imports a snapshot of the HTML page 1234 into word processing software 1200 and onto the first sheet of a new word processing document 1210. The developer may then modify the web page's layout to improve its appearance so that it is more appropriate to a word processing application.

The HTML page being rendered will typically include some content that changes infrequently, if at all, and other data or content that changes in response to user actions, remote data updates, and so forth. For example, a web page maintained by an information provider that displays stock prices information will generally include some information that remains essentially constant, such as the page layout, ticker symbol, information provider's name and logo, as well as other information that requires frequent updating, such as stock prices and performance data. The present invention distinguishes between these “static” and “dynamic” content elements, and manages them in different ways.

The static portions of the HTML Web page are preferably rendered in the word processing version of the page as static data within the UI of the embedded application web page. In one embodiment, static HTML text and images may be incorporated in the word processing document using the base HTML import operation of word processing productivity application 1200, if included.

According to one embodiment, the dynamic portions of the HTML Web page are rendered as one or more named cells, charts, or other controls. The developer links these UI elements to state-information elements that may, for example, be stored in a second word processing or elsewhere in computer memory. These state-information elements can themselves be linked to one or more queries stored, for example, in a third word processing document or elsewhere in memory or the information model 790. At runtime, these queries are executed and the query results are stored as state information in the linked state-information elements. This state-information is then used to populate the dynamic portions of the web page within the word processing document.

It may also be desirable to include form elements to allow an end-user to enter “form data,” such as the stock symbol whose price the end-user wishes to retrieve. These form elements are preferably rendered as one or more cells of a table or other controls, such as entry fields, pick lists, and the like, on the first word processing document 1210. The developer links each such UI form element to one or more state-information elements preferably stored in cells on the second page of the spreadsheet 1220 or elsewhere in memory. Information entered by a user in a form element on the first word processing document is passed back to these linked state-information elements for further processing or transmission to web server 1214.

The developer then refines the embedded application UI by hiding distracting elements that will not be needed by users in typical operation of the document 1210, such as secondary scratch sheets and extraneous toolbars. Using tools provided by the invention, the developer may decide to restrict or otherwise control the extent to which an end-user may modify or interact with the new web page. The embedded application web page 1210 is then placed into run mode which may prevent any disruption of the UI by users. The completed enhanced word processing web page 1210 is then posted to web server 1214 as custom embedded web page 1236. This deployment may include providing links to the embedded application web page 1236 from other pages, such as the HTML page 1234, on the same or other web sites.

A user at computing device 1240 may download the embedded application web page 1236 from web server 1214 by opening the page in word processing software 1260 directly or by its hyperlink, which also causes the page to automatically be opened in word processing software 1260 as the enhanced word processing document 1270. The network-functionality software 1250 and the runtime code in the enhanced word processing document 1270 cooperate to execute any queries to retrieve population data elements as specified by the developer. The contents of these elements are used to populate the dynamic data regions of the first word processing document 1270, which may then be displayed to the user.

While viewing the enhanced word processing document 1270, the user has available all functionality provided by word processing software 1260 that the web page developer has left accessible. For example, if the displayed page contains raw stock data, the end-user may use the word processing software's chart functionality to create a chart from said data. In addition, a scratchpad area may be provided on an additional sheet of the word processing document that allows the user to perform arbitrary calculations and manipulations based on the data displayed on the web page. The user may also link to data on the web page from a second word processing application or other program running on computing device 1240. Furthermore, if the user enters a new stock symbol to be charted, the relevant data will be returned to the client via a population data query and charted, causing only the updated areas of the client-side embedded web page 1270 to be updated. As a result, the present system provides high update and refresh performance. It should be noted that custom analysis can be performed locally as opposed to constant calls to the network.

FIG. 13 provides a provides a detailed flow of the operation by a developer to create a web page in accordance with the present invention, using a word processing productivity application 1200 that has been provided with a network-functionality software 1220. In step 1302, the developer launches word processing productivity application 1200. Launching the word processing productivity application 1200 also launches the network-functionality software 1220, including the developer tools and user tools. In this embodiment, developer tools of the network-functionality software 1220 add a developer's toolbar to word processing productivity application 1200 for inserting macros and UI elements into the word processing document 1210. These tools may be made available on one or more developer's toolbars or menus that become embedded in the software's UI.

In one embodiment, the toolbar may include a “new Web page” button for creating a new word processing web page by providing a rendering of a web page as an enhanced word processing document. In step 1304, the developer clicks on the “new Web page” button. In step 1306, the system presents to the developer a wizard containing a palette that displays a selection of templates for designing a web page. In addition, the wizard may include a “browse to web page” button.

According to the present invention, it is assumed that the developer wishes to create a word processing web page that “mirrors” an existing browser-based page, rather than create a word processing web page from scratch. Accordingly, in step 1308, the developer clicks on the “browse to web page” button on the developer toolbar. In step 1310, a browsing window pops up within the document's UI and the developer browses to and selects the web page that the developer wishes to copy. According to one embodiment, the developer browses to a web page 1234 displaying stock price performance.

In step 1312, a snapshot of the selected web page is imported onto the word processing document 1210. This step may employ the native HTML import functionality of the word processing productivity application 1200.

As those skilled in the art will recognize, the native HTML import functionality of spreadsheet programs typically create layout errors, including overlapping and obscured items. Consequently, in step 1314, the developer may be provided with a tool for cleaning up any layout problems created by the format translation. Alternatively, the developer tools in the network-functionality software 1220 may be provided with its own HTML import functionality that does not introduce these layout problems. However, it should be noted that the developer laying out a spreadsheet web page should preferably visualize the page in terms of the optimal layout for the spreadsheet application environment, rather than attempting to copy exactly the look and feel of the page's browser-based version. However, this should preferably also be balanced with the desire to maintain as consistent a look and feel between the two versions as possible.

In step 1316, the developer defines state information associated with the embedded application web page 1210. Each state-information element is implemented as a named property, using developer tools provided to create and manage the properties. These elements may be stored as data values in, for example, cells of a table in word processing document that is accessible to the developer but may not be accessible to the user. Alternatively, state information may be stored elsewhere in memory or the information model 790 and referenced only by name. Using the state-information manager, the developer defines individual properties of the state information element and optionally specifies a data type, such as string, numeric, dollar, date, and the like, and a default value for the property. Once defined, the document code in the document 1210 and/or network-functionality software 1250 allows the element to be referenced elsewhere in the application by property name.

In step 1318, the developer uses the developer tool that is provided to define one or more queries for retrieving dynamic data at runtime. These query specifications may be static, i.e., contain no variables, or may alternatively be a function of one or more named state-information elements. These queries and query results may also be located in cells of another word processing document or alternatively stored elsewhere in memory.

A query manager may be provided as a developer tool, for facilitating the creation and management of these queries. When the developer wishes to define a query, the query manager creates a new data item and displays a dialog box that prompts the developer to enter the desired query. For example, if the developer wishes to create a query that retrieves the stock price information, the developer might enter a URL query and specify that data returned by the query should be stored in a data item that may be labeled StockData.

In an exemplary, the “%stocksymbol%” sub-string may be used to indicates that the current value of the StockSymbol state-information element should be substituted into the query before it is executed at runtime. This symbol substitution and name reference capability is provided to the end-user by user tools in the network-functionality software 1250. A “data=raw” sub-string may be provided to indicate to the web server that it should return the raw data, possibly encoded in an HTML table. At runtime, the query will be executed by end-user network-functionality software 1250 and the returned data stored in the StockData data item, which may then be referenced by name in other fields and controls in word processing document 1210.

In addition, the query manager may be adapted to automatically create a query to retrieve data identified by the user. According to one embodiment, the query manager may permit a developer to direct a browser to a web page and select, for example, a field on the web page with a mouse. The query manager may then automatically formulate an appropriate query for retrieving data through end-user tools in the network-functionality software 1250.

In step 1320, the developer links dynamic-data and form-data values and other fields on the first word processing document to particular state-information or user interface elements. For example, the developer may link the Stock Symbol property defined above to the entry field on the word processing web page. It should be noted that the system may be adapted to allow these elements to be referenced by name in formulas and macros so that the developer need not be aware of where or how they are stored.

In step 1322, the developer creates the word processing application-based chart that will replace the static image used in the original HTML page, which is generated during the import step 1312. In particular, the developer deletes that static image from the first page of the word processing document 1210, selects the area or table of the page that the chart should occupy, and launches the wizard for the word processing application 1208. In the wizard, the developer selects one of the standard line or area charts and then specifies the data source for populating the chart, which in this case is the StockData data item described above. This connects the chart to the dynamic data stored in the StockData data item. The developer then sets the chart's display properties, such as scaling, labels, axis details and so forth, as desired.

In step 1324, the developer may lock or otherwise disable portions of the UI that will be presented to users when word processing document 1210 is opened during runtime. During this step, the developer selects areas of the first word processing document that should be read-only and presses a “freeze” button on the developer's toolbar. This locks the selected portions of the document so that they cannot be selected and manipulated by the user. Also during this step, the developer may specify word processing documents as invisible to the user. In the present embodiment, the developer will typically designate only the first word processing page as visible. In addition, the developer may wish to hide any standard word processing toolbars that are inappropriate for the particular word processing web page.

In step 1326, the developer presses a mode toggle button provided on the developer toolbar, causing the end-user tools to take over the word processing application and enforce the embedded application web page behavior that has been designated by the developer. The developer may then work locally on the client machine with the web page in runtime mode to verify that the embedded application web page functions properly.

In step 1328, the developer posts the word processing application web page to the web server 1214 and provides a link to the page to allow users to access it. For a more seamless and integrated experience, the developer may additionally utilize a redirector module that runs on the web server in response to end-user requests for the stock web page and transmits either the browser version or word processing version of the web page to a particular user based on any of a number of possible criteria.

FIG. 14 provides a detailed flow of the operation by a user to use a web page created in accordance with the present invention. In step 1402, the user clicks on or otherwise opens a hyperlink associated with a word processing web page 1236. This hyperlink may be a direct link to the enhanced web page 1236 or a link that invokes redirector software at web server 1214. In the latter case, the redirector software can return either the browser web page 1234 or the enhanced word processing page 1236 based on either client capabilities—namely, whether or not the word processing productivity application 1200 and user network-functionality software 1250 are available on client machine 1240, or on preferences for the specific user. Such preferences may be based on the type of enhanced document or on the particular page or on the web site as a whole or upon other controlling criteria. The page is transmitted to user's client machine 1240 in step 1404 and automatically opened within word processing software 1260. Where enabled, this operation may open the word processing application within the launching browser container using available systems mechanisms such as Active Document Servers and multiple-document interfaces (MDI).

In step 1406, user network-functionality software 1250 and runtime code in the downloaded embedded application web page 1270 cooperate to execute any queries in the web page and to store the returned data in one or more population data elements. In step 1408, this state information is used to populate any designated dynamic-data regions of the first word processing document. In step 1410, the complete “web page” is displayed to the user in the productivity application format. As noted above, while viewing the page, the end-user has access to all built-in word processing functionality of productivity application 1260 allowed by the developer. As a result, the user can still do table analysis, refer to cells, create charts and figures, create frees-standing network content at a desired location outside of a table, embed other document types with or without network-based content, and the like.

In some implementations of this embodiment, end-user network-functionality software 1250 and runtime code in web page 1236 may cooperate with a web server extension 1230 of FIG. 12 to periodically re-execute a query or otherwise update the dynamic data used to populate the web page. For example, a “time until stale” field may be associated with each query included in the word processing web page. When this time expires, end-user network-functionality software 1250 determines whether an appropriate network connection still exists for updating the dynamic data associated with the query. If the connection still exists, the query is run again, and the dynamic data displayed on the web page is updated with the latest query results. Alternatively, web server extension 1230 may detect that data associated with a registered query in enhanced document web page 1270 has changed and proactively push updated query results to the document for viewing at the client.

In some implementations of this embodiment, the developer constructing embedded application web pages may find that two or more pages at a given Web site (or, for that matter, all pages at a given site) are related and appropriate to be rendered as embedded application web pages. In this case, a word processing version of each of the two or more pages may be created and stored within a single enhanced word processing document. These documents may be linked such that navigating from one to another merely results in the display of a different view in the same enhanced spreadsheet document. This capability of storing multiple web pages within a single document provides the ability to improve interoperability and integration between what were originally disconnected pages. It also provides the ability to cache, snapshot, or transmit entire web sites or portions of web sites, and work within an entire web site while disconnected from the hosting network, after having downloaded the single enhanced word processing document containing the multiple embedded application Web pages, and also caching snapshots of any needed population data query results.

As the discussion relating to FIGS. 12-14 illustrates, one embodiment of the present invention enables the development of web pages, web applications and even web sites that can be accessed directly within non-browser client applications, such as word processors, spreadsheet programs, graphics applications and the like. The invention exploits both the power of the productivity application, for content manipulation, calculation capabilities and the like, and distributed and web-based functionality typically which were previously available only through a separate web browser.

In retrieving network-based content, a user operates a client terminal which is in communication with a server. The server receives a query entered by the user and locates a web-site or the like on a network, such as the Internet, which maintains dynamic data responsive to the query. The query may be stored in one or more repositories. On the client terminal, the repository may be formatted for extensible mark-up language (XML) files. On the server, the repository may exist in a lightweight directory access protocol (LDAP) format. This is because the server may handle requests from a large number of users, thereby necessitating a larger storage capacity more suitable to LDAP or other equivalent structures.

Referring to FIG. 15, therein is depicted an exemplary process 1500 performed by a user for selecting network-based content (i.e. population data) that can be updated through use of a network-enabling object, and for inserting the population data into a table in a word processing document on the client terminal. The process 1500 begins when a user accesses a menu or toolbar listing network-enabling functionality, such as is displayed in exemplary FIG. 16A (step 1502). Upon selection of, for example, an “edit table” option (step 1504) as displayed in exemplary FIG. 16B, a wizard is launched (step 1506) for facilitating the insertion of network based functionality within the table. The selection of the wizard may result in the launch of a UI similar to that depicted in FIG. 16C. In particular, the selection may call visual basic application (VBA) code which initiates the dynamic link library (DLL) object corresponding to the wizard. The user may use the wizard to position and populate one or more cells of the table and to select a size of the data to be retrieved and inserted therein, as described immediately below. Such selection may be displayed in a preview window provided in the wizard view, as shown in exemplary FIG. 16C. The preview window may be a WYSIWYG (what-you-see-is-what-you-get) display, as is readily known in the art.

After the wizard is launched, the user may then select input and output views for the table (step 1510). Input views include a parameter selected by the user for which corresponding network-based data (i.e. population data) will be retrieved, displayed, and/or updated. The input view may be disabled or enabled, respectively, by, for example, selecting or de-selecting a checkbox 1630 as shown in FIG. 16D. The table may be listed and or named in an appropriate table identification box 1640 as displayed in FIG. 16D.

The output view corresponds to one or more cells that may be designated by the user or selected by the wizard when no such designation is received from a user. To select an output view, the user may, for example, select a “value” button provided in the display of FIG. 16D. Upon such selection, a parameter information dialog box, such as displayed in exemplary FIG. 16E may be presented. The user may next enter the column and row (i.e. parameter information) (step 1512) corresponding to a cell in the selected table. In the absence of a selection by the user, the wizard may select a default column and row for insertion of such data, which may be, for example, the next available cell for receiving network-enabled data.

The user may then be prompted to enter table definitions (step 1514). To accomplish entry of such definitions, the wizard may present a table options dialog box, as displayed in exemplary FIG. 16F. This dialog box allows the user to define, inter alia, a maximum number of rows for the table and whether the data selected for the output view is to be updated when the corresponding value taken from the network location is changed. Upon completion of the table definitions, the table is created and the population data and input view may be inserted according to the user's selections (step 1516). The table may then be displayed to the user within the word processing document, as shown in any of FIGS. 11A-11C, or in any other equivalent manner.

After the table has been displayed, the user may optionally manipulate the size of the displayed table (step 1518) as shown in FIG. 16G. To accomplish this, the user may select and “grab” an end of the table or a cell of the table using a mouse or other command input device. The user may then designate a new table size in relation to the word processing document by manipulating and repositioning the table end or selected cell in the display. After such manipulation of the table display, the process 1500 ends.

Referring now to FIG. 17, therein is depicted an exemplary process 1700 for inserting network-based content at a designated insertion point in the word document. The process 1700 begins at step 1701 where a user selects an insertion point for network based content. The insertion point may be defined, for example, by using a mouse to select a position on a displayed word processing document. Alternatively, the user may use a keyboard or other input device to position a cursor in the word processing application at a desired location within the word processing document.

Next, the user may initiate a text insertion wizard by, for example, selecting an appropriate option from the toolbar displayed in exemplary FIG. 16A (step 1702). The text insertion wizard may then be launched and displayed in, for example, a text wizard dialog box as shown in exemplary FIG. 18F (step 1704). The user may then select a stored or “pre-canned” query displayed by the wizard, or may choose to define new query parameters (step 1706). The queries may correspond to network-based content that is to be inserted into the word processing document. If a pre-canned query is selected, the process 1700 continues to step 1724 below. Otherwise, the process 1700 continues to step 1708 where the user may select a new query.

In order to specify query input parameters, the user may be presented with a query wizard parameters dialog box 1810, such as is depicted in exemplary FIG. 18G. A plurality of available query parameters may be presented in a first area 1820 of the exemplary query wizard dialog box 1810. The user may then input default parameter values or create a control for the user to input dynamic parameters by selecting a “create control” button 1830 from the query wizard dialog box 1810. If an available query is selected, the process 1700 continues to step 1724 below. Otherwise, the process continues to step 1710 where the user enters a name for the new parameter. The new parameter may be entered into a parameter field 1840 embedded in the word processing document as displayed in exemplary FIG. 18H.

When creating a control or dynamic input entry within the content of the word processing document, the user is next presented with an input parameter control dialog box as displayed in exemplary FIG. 18I. The input parameter control dialog box allows the user to select whether the input parameter is to be placed in the word processing document is a List Box or a Text Box (step 1712). The List Box allows the parameter to be selected from a pulldown menu of available parameters or the like. If the text box option is selected, the user may further enter the width of the text box to be inserted. If no width is selected, the wizard may enter a default value which may be based on the amount of network based content retrieved in response to the new query.

The user is then presented with a datasource dialog box for defining the source for the network-based content to be provided in response to the query parameter. The datasource dialog box may be as depicted in exemplary FIG. 18J. The datasource may be, for example, a database, a screen scrape of a web page, a .CSV file, data feed from a content provider such as BLOOMBERG, or other equivalent sources. The datasource dialog box may include fields for entering (1) the location of the network source (i.e. a URL of a network location for the content), (2) whether the content is to be placed as a text box or as standard text, (3) whether the data is to be updated when the network content changes at the selected content source, and (4) the maximum number of characters, words and or lines of text for the retrieved network-based content.

The user is next provided with a information source property dialog box (step 1716), such as displayed in exemplary FIG. 18K, where portions of the selected source may be listed as parameters for the query. The portions may correspond to the network-based content that is to be scraped from the network source and displayed in the word processing document. The user may then optionally designate that the same data is to be returned for such parameters, or that the parameters may be changed or updated.

Upon selection of the information source properties, the user may be presented with a preview dialog box, such as is displayed in exemplary FIG. 18L (step 1718). The preview dialog box may include a WYSIWYG display of the selected network-based content within the word processing document, and may further provide options for the user to manipulate various attributes of the network-based content, such as font, font color, justification, underlining, bold-face, italics, and the like.

Upon selection of the various attributes and any additional desired query parameters (through, for example, one or more repetitions of steps 1708-1718 above), the user may then be presented with a parameter name value dialog box, such as that displayed in exemplary FIG. 18M. The user enters the value of the parameter which is then stored by the wizard (step 1720).

The process 1700 then continues to step 1722 where an information source dialog box is presented for storing an identification of the network source for the saved query. The information source dialog box may include fields for storing a user-selected name of the source, a description of the source, and for designating how the source is to be stored (i.e. within the word processing document, or a central library of query parameters).

The network-based content corresponding to the query may then be inserted in the word processing document at the insertion point initially designated by the user (step 1724). Examples of such text insertion appear in exemplary FIGS. 18A-18E. As shown in FIG. 18A, the query parameter may be presented in one location on the word processing document, with the network-based content corresponding to the query parameter displayed at a second location. Additionally, the network-based content may be displayed without the query parameter and inserted in between non-networked based content, as shown in FIG. 18B. The network-based content may further be displayed with an embedded table for entry of non-network based content as displayed in FIG. 18C. The network-based content may further be displayed before any non-network-based content, as shown in FIG. 18D. Also, non-network based content may be displayed within the network-based content without an embedded table, as shown in FIG. 18E. As will be appreciated by one of ordinary skill in the art, additional configurations of the display of network-based and non-network-based content may be accommodated within the spirit of the present invention.

Next, at step 1726, the user may optionally alter one or more of the attributes of the network-based content after insertion into the word processing document. Such alterations may include any of: editing the query parameter, deleting the content, refreshing the network-based content, resetting source properties for the content and viewing or altering the parameter name. After optional step 1726, the process 1700 ends.

In additional embodiments of the present invention, the network-based content may be inserted into a compound document, namely, a document having more than one document types associated with it. Such a compound document may be a word processing document with an embedded spreadsheet (or other type of) document. The embedded document may have network-enabling objects placed by their corresponding productivity application. For example, an embedded spreadsheet document within a word processing document may have network-enabling objects defined by a spreadsheet productivity application. It is contemplated that in such an embodiment, the spreadsheet network-enabling object will be able to be selected, understood and updated from within the compound document. That is, such an object will be able to be updated and manipulated in the same manner as any word processing network-enabling objects within the compound document. The runtime from the word processing application or the spreadsheet application may be used for such object handling. On the other hand, if a compound document is opened without the appropriate network-content runtime from either the word processing or spreadsheet productivity application being available, the user viewing the compound document may receive a notification that updating of the network-enabling objects is unavailable.

Although particular arrangements of display screens and order of steps have been presented and described above with respect to FIGS. 15-18M, it is to be understood that the data and functionality described therein may be selected, displayed or manipulated in other equivalent manners.

As is made apparent by the examples provided herein, the invention provides for integration of new network enabling functionality into existing productivity applications such that users, as opposed to developers, can easily create and interact with enhanced documents that leverage a variety of distributed services, and that it provides the means for existing service providers to broaden their utility, and overall value through greatly expanded access and availability.

The described architecture for the method and system of the present invention provide a wide array of both client- and server-side benefits. It enhances the functionality available to a user by facilitating connection to network-based services (e.g., Web browsing, conferencing, chat, e-mail, licensing, and workflow), and making these services available within spreadsheet productivity applications. Additionally, because the enhanced productivity application is “network aware,” it can provide the end-user with distinct on-line and off-line usage models. For example, the augmented desktop application may, during on-line usage, provide access to network services and, during off-line usage, allow the end-user to work on previously downloaded content. In addition, data entered by the end-user during off-line usage may be stored for later upload and subsequent processing by a server (i.e., synchronization).

Furthermore, the productivity application with the network-based functionality enhances the UI provided to both developers and users. This enhanced UI may include nonstandard toolbars and buttons for launching special-purpose tools and executing commands as described above.

In addition, because the enhanced application can connect to one or more remote servers, the system may efficiently allocate tasks between client and server. For example, a server may be tasked with collecting, processing, and formatting data required by an enhanced application. Enhanced pipes may be established between server and client to facilitate downloading of this information. Both clients and servers may also intelligently pre-fetch content and data in order to respond to anticipated requests by a user. The ability to replicate at least a portion of a Web site within a word processing application, and install such a productivity application-based site on a client machine, can improve performance because only real-time dynamic data (i.e., population data) must be obtained over the Internet from the server. Because the present system provides for the separation if desired of wireframe and population data, the wireframe may be treated as a versioned and infrequently downloaded independent element. This decreases bandwidth requirements with use and improves the end-user experience by decreasing screen-refresh times. It also enables more efficient caching of multiple instances at the client because the wireframe is cached only once. Custom, licensed, or public-domain differencing techniques may be employed to exploit this aspect of the present invention. In addition, this separation may be extended to multiple population data blocks per page, each of which can be managed and updated independently.

Furthermore, the present system facilitates optimal workload balancing between client and server. In many cases, it may be desirable to assign various background and agent-type tasks to the server. For example, the server may be programmed to monitor a Web site for changes, and notify the client when a change is detected. Document control (e.g., managing who has permission to modify a document), workflow processes, and productivity application-based conferencing may also be centrally managed by a server. The server may be programmed to detect obsolete versions of runtime code or wireframes on the client and update that code, either automatically or under the end-user's explicit control.

The above architecture facilitates both unstructured use as well as more structured use. Structured use denotes the concept of a packaged application. If one restricts a user's operations, the productivity application has transformed into a new more specialized application, which leverages the desired functionality of the original productivity application. The invention can also be used in unstructured formats, typically in the form of user tools. The user tools will provide quick utilities to enhance the power of the productivity application, such as a screen scraper. Thus, the invention is useful in the format of a highly structured application, quick unstructured utilities, and any type of computer program in between.

Users are also preferably provided with access to, and some control over, runtime utilities via the above architecture. For example, users may initiate conferences and chat sessions with each other from within their augmented desktop-application environments.

Furthermore, since numerous modifications and variations will readily occur to those skilled in the art, it is to be understood that that the present invention is not limited to the exact construction and operation illustrated. Accordingly, all suitable modifications and equivalents are intended to fall within the scope of the appended claims.

What is claimed is:

1. A computer program with network-based functionality, comprising:
code for displaying a word processing document capable of operation in connection with a productivity application resident in computer memory;
code for coupling at least one network-enabling object to said word processing document, wherein said at least one network-enabling object is configured to provide network-based functionality to said word processing document; and
network-functionality code for allowing the productivity application to interpret the at least one network-enabling object.

2. The computer program of claim 1, further comprising linking code that enables said at least one network-enabling object to link to said network-functionality code.

3. The computer program of claim 2, wherein said at least one network-enabling objects is embedded in at least one cell of a table of said word processing document.

4. The computer program of claim 2, wherein said at least one network enabling objects is embedded at an insertion point of said word processing document.

5. The computer program of claim 2, wherein said at least one network enabling object is embedded within a second document type within said word processing document.

6. The computer program of claim 5 wherein said second document type comprises a spreadsheet.

7. The computer program of claim 1, further comprising linking code operative with said network-functionality code, wherein said linking code allows said network-functionality code to function in combination with said at least one network-enabling object to deliver said network-based content within said word processing document.

8. A word processing document with network-based functionality that may be used with a network-enabled productivity application, comprising:
a wireframe, including scripting code that remains static during a run time of a productivity application, said wireframe comprising at least one of: static data and query configurations; and
native script code operative with said wireframe to provide network-based content within said word processing document.

9. A method of creating a word processing document having network-based functionality using a network-enabled productivity application, comprising:
launching a network-enabled productivity application;
opening a word processing document with the network-enabled productivity application; and
instructing said network-enabled productivity application to embed at least one network-enabling object for importing network-based content into said word processing document, wherein said embedded at least one network-enabling object is linked to network-functionality code such that use of the embedded at least one network-enabling object is interpretable by the productivity application.

10. The method of claim 9, further comprising:
saving said word processing document with the at least one embedded network-enabling object therein.

11. The method of claim 9, wherein said launching the network-enabled productivity application comprises:
launching the productivity application; and
launching network-functionality code, which enables network-based content to be viewed within the productivity application.

12. The method of claim 10, wherein said instructing said network-enabled productivity application comprises launching decryption code for viewing encrypted network-based content within the word processing document.

13. The method of claim 9, wherein said instructing said network-enabled productivity application further comprises placing said network-functionality code into a hidden area of the word processing document.

14. The method of claim 9, wherein said at least one network-enabling object is embedded in at least one cell of a table of said word processing document.

15. The method of claim 9, wherein said at least one network enabling object is embedded at an insertion point of said word processing document.

16. The method of claim 9, wherein said at least one network enabling object is embedded within a second document type within said word processing document.

17. The method of claim 16 wherein said second document type comprises a spreadsheet.

18. A method of using a word processing document with network-based functionality within a network-enabled productivity application, comprising:
launching a network-enabled productivity application; and
opening a word processing document having code for providing network-based functionality in conjunction with at least one network-enabling object.

19. A method of using a word processing document with network-based functionality within a network-enabled productivity application, comprising:
launching a network-enabled productivity application;
opening a word processing document from within said productivity application; and
activating at least one embedded network-enabling object for providing network-based content within said word processing document, wherein said at least one embedded network-enabling object provides a continuous feed of network-based content to said word processing document.

20. A method of generating a word processing document with network-based functionality embedded therein, comprising:
launching a network-enabled productivity application upon a request from a user;
opening a word processing document from within the productivity application upon a general request from a user; and
embedding at least one network-enabling object to import network-based content into said word processing document upon a third request from a user.

21. The method of claim 20 further comprising:
saving said word processing document with said at least one embedded network-enabling object therein.

22. The method of claim 20, wherein said embedding comprising:
reading network-functionality code from a storage area associated with said word processing document,
encrypting the network-functionality code for said at least one network-enabling object, and
placing said encrypted code into a hidden area of the word processing document to create packed encrypted code.

23. A method for generating a word processing document with network-based functionality for use with a network-enabled productivity application, comprising:
launching a network-enabled productivity application upon request from a user;
opening a word processing document within said productivity application upon request from said user;
receiving instructions from said user to embed at least one network-enabling object that provides network-based content into said word processing document.

24. The method of claim 23, further comprising:
embedding said at least one network-enabling object into said word processing document.

25. The method of claim 23, further comprising:
saving said word processing document with said at least one embedded network-enabling object therein.

26. A method of running a network-enabled productivity application for providing network-based functionality to a word processing document, comprising:
launching a network-enabled productivity computer application upon request from the user;
opening a word processing document with said network-enabled productivity application upon request from the user, said word processing document containing network-functionality code for at least one network-enabling object that provides network-based functionality to said word processing document; and
unpacking said network-functionality code for said at least one network-enabling object embedded in said word processing document.

27. The method of claim 26, wherein said network-functionality code is provided in an encrypted format, said unpacking further comprising decrypting the network-functionality code for enabling said at least one network-enabling object to be embedded in said word processing document.

28. A method of using of a word processing document with network-based functionality embedded therein in conjunction with a network-enabled productivity application, comprising:
launching a network-enabled productivity application upon request from a user;
opening a word processing document from within said network-enabled productivity application upon request from said user;
changing the contents of said word processing document upon instruction from said user; and
storing said word processing document.

29. The method of claim 28, wherein said word processing document contains packed network-functionality code in an encrypted format for embedding at least one network-enabling object that provides network-based functionality to said word processing document.

30. The method of claim 29, further comprising unpacking said network-functionality code for said at least one network-enabling object in said word processing document after said opening.

31. A method for loading a word processing document with network-based functionality with the use of a network-enabled productivity application, comprising:
launching a network-enabled productivity application upon request from a user;
opening a word processing document within said productivity application upon request from said user;
receiving an indication of said opening of said word processing document by an installed base service in said network-enabled productivity application;
detecting, with said installed base service, at least one network-enabling object;
reading embedded network-functionality code associated with said word processing document to incorporate network-band content corresponding to the at least one network-enabling object into said word processing document.

32. A method for transmitting a word processing document with network-based functionality from a central server for use with a network-enabled productivity application launched on a remote terminal, comprising:
establishing a connection with the remote terminal by a server, wherein said server has a word processing document with network-based functionality stored therein;
receiving a request for said word processing document from said remote terminal; and
transmitting said word processing document to said remote terminal in response to said request .

33. The method of claim 32, further comprising authenticating a user operating said remote terminal after said establishing said connection.

34. The method of claim 33, wherein said authenticating comprises:
receiving identification information from said user; and
determining a login status of said user band on said identification information.

35. A method performed by a server for transmitting a word processing document with network-based functionality for use with a network-enabled productivity application performed by a server, comprising:
establishing communication with a remote terminal;
authenticating a user associated with the remote terminal;
receiving a request from said remote terminal to download a word processing document with network-based functionality; and
transmitting the word processing document with said network-based functionality to the remote terminal.

36. The method of claim 35, wherein said establishing further comprises:
establishing a secure connection with said remote terminal.

37. A method for transmitting a word processing document with network-based functionality for use with a network-enabled productivity application operating on a remote client, comprising:
receiving a request from a remote client at a web server for downloading a requested word processing document with network-based functionality:
authenticating said remote client; and
transmitting the requested word processing document to said remote client.

38. The method of claim 37, wherein said authenticating comprises:
receiving authentication information from said remote client.

39. The method of claim 37, further comprising selecting a version of the word processing document to be transmitted to said remote client based on the productivity application.

40. A productivity application, comprising:
means for displaying a user-readable representation of a word processing document operating in conjunction with a productivity application; and
means for providing network-based functionality to said word processing document.

41. The productivity application of claim 40, further comprising: means for linking said providing means to said displaying means representation, wherein said linking means enables said the providing means to receive said network-based content within the word processing document from a network.

42. A computer readable medium encoded with processing instructions for implementing a method of enabling network functionality within a word processing document, the method comprising:
displaying a user-readable representation of a word processing document;
and linking at least one network enabled object to said word processing document for delivering network-based content thereto.

43. A word processing document having network-based functionality and embedded network-functionality code that may be used with a productivity application, comprising:
a word processing document capable of operating under a productivity application resident in computer memory; and
at least one network-enabling object coupled to said word processing document, wherein said at least one network-enabling object is configured to provide network-based functionality to said word processing document.

44. The word processing document of claim 43, further comprising linking code that enables said network-enabling objects to link to said word processing document.

45. The word processing document of claim 43, wherein said at least one network-enabling objects are embedded in said word processing document.

46. The word processing document of claim 43, further comprising linking code software resident in the computer memory, which allows said at least one network-enabling object to deliver network-based functionality to said word processing document.

47. A word processing document with network-based functionality that may be used with a productivity application, comprising:
a wireframe including data and scripting code that remains static during a run time of a productivity application, said wireframe further comprising:
at least one embedded network-enabling object to provide network-based functionality from within said word processing document, said at least one embedded network-enabling object in communication with native user interface, and
code for allowing said at least one network-enabling object to launch the network-based functionality from within the word processing document; the word processing document further comprising:
native script code for cooperation with said wireframe, to provide functionality to native functions of said word processing document.

48. A word processing document having network-based functionality for use with a network-enabled productivity application, comprising:
a wireframe, wherein said wireframe comprises static scripting code that maintains its state during a run time of the productivity application;
population data dynamically generated by a network enabled object to populate the wireframe during the run time of the productivity application, and
form data entered by a user during the run time of the productivity application for interaction with the wireframe and the population data of the word processing document.

49. The word processing document of claim 48, wherein said wireframe comprises at least one network-enabling object to provide network-based functionality to said word processing document.

50. The personal computer document of claim 49, wherein said form data is transmitted to a server over a network connection that provides feed for the network-based functionality.

51. A method of creating a word processing document having network-based functionality and embedded network-functionality code, comprising:
launching a network-enabled productivity application; opening a word processing document using the productivity application;
embedding at least one network-enabling object that implements network-based functionality into said word processing document;
embedding network-functionality code in said word processing document, wherein said network-functionality code provides functionality to said at least one embedded network-enabling object; and
saving said word processing document with said embedded network-enabling objects and said embedded network-functionality code therein.

52. The method of claim 51, wherein said launching comprises: launching the productivity application; and
launching network-functionality software, wherein said network-functionality software is linked to said productivity application such that the network-functionality software adds network-based functionality to said productivity application.

53. A method of creating a word processing document having network-based functionality and embedded network-functionality code, comprising:
launching a productivity application;
opening a word processing document within the productivity application;
embedding at least one network-enabling object that implements network-based functionality into the word processing document, said at least one embedding network-enabling object comprising encrypted code for said at least one network-enabling object stored in a hidden area of the word processing document; and
embedding network-functionality code in said word processing document, wherein said network-functionality code provides functionality to said at least one embedded network-enabling object, said embedding network-functionality code comprising encrypted network-functionality code stored in said hidden area of personal computer document.

54. The method of claim 53, further comprising:
saving said word processing document with said at least one embedded network-enabling object and said embedded network-functionality code therein.

55. A method for generating a word processing document having network-based functionality and embedded network-functionality code, comprising:
launching a network-enabled productivity application upon request from a user;
providing a word processing document maintained by said productivity application; embedding at least one network-enabling object to implement network-based functionality into said word processing document by coupling said at least one network-enabling object to said word processing document; and
embedding network-functionality code into said word processing document, wherein said network-functionality code provides functionality to said at least one embedded network-enabling object for allowing display of network-based content.

56. The method of claim 55, further comprising:
storing said word processing document with said at least one embedded network-enabling object and said embedded network-functionality code therein.

57. A method of generating a word processing document with network-based functionality and network-functionality code embedded therein, said word processing document maintained by a network-enabled productivity application running therewith, the method comprising:
launching a network-enabled productivity application upon request from a user;
opening a word processing document upon request from a user;
embedding at least one network-enabling object to implement network-based functionality into said word processing document upon request from a user, said embedding comprising:
reading code from a native script code storage area in said word processing document, and
encrypting code for providing network-based functionality in said word processing document; and
embedding the network-functionality code into said word processing document, wherein said network-functionality code provides functionality to said at least one embedded network-enabling object.

58. The method of claim 57, further comprising:
storing said word processing document with said at least one embedded network-enabling object therein.

59. The method of claim 57, wherein said embedding network-functionality code into said word processing document further comprises encrypting said network-functionality code after reading said code from said native script code storage area.

60. The method of claim 59, wherein said embedding network-functionality code into said word processing document further comprises placing at least portion of said encrypted network-functionality code and said at least one network-enabling object into a hidden area of the word processing document to create packed encrypted network-functionality code after said encrypting said network-functionality code.

61. A method for updating a word processing document having network-based functionality in conjunction with a productivity application, comprising:
launching a productivity application upon request from a user;
opening a word processing document from within said productivity application upon request from said user, said word processing document containing network-functionality code and at least one network-enabling object that provides network-based functionality to said word processing document;
unpacking said network-functionality code in said word processing document; and
changing a portion of said word processing document upon instruction from said user.

62. The method of claim 61, wherein said unpacking of network-functionality code comprises activating code for unpacking to run in a productivity application extender of the network-functionality code.

63. The method of claim 62, wherein said unpacking of network-functionality code further comprises decrypting said encrypted network-functionality code and code for said at least one network-enabling object in said word processing document upon deployment of executor code in said native script engine.

64. A method for transmitting a word processing document having network-based functionality and embedded network-functionality code by a remote terminal, comprising:
establishing communication with a remote terminal at a sever, wherein said server has access to a word processing document having network-based functionality and embedded network-functionality code;
authenticating an identity of a remote user corresponding to the remote terminal; and
transmitting the word processing document with network-based functionality to the remote terminal, substantially upon authentication of the remote user.

65. A method for transmitting a word processing document with network-based functionality embedded therein for use with a productivity application by a remote client, comprising:
receiving a login request from a remote client;
receiving a request from said remote client for downloading a word processing document with network-based functionality; and
transmitting the requested word processing document with network-based functionality to said remote client, said word processing document comprising network-functionality code and at least one network-enabling object for launching said network-based functionality from within said productivity application.

66. The method of claim 65, further comprising:
selecting a version of word processing document to be transmitted to said remote client.

67. A word processing document with network-based functionality having embedded network-functionality code that may be used with a productivity application, comprising:
means for displaying a user-readable representation of word processing document data capable of running on a productivity application resident in computer memory;
means for providing network-based functionality to said word processing document; and
means for linking said providing means to said displaying means, wherein said linking means enables said providing means to deliver network-based functionality within said word processing document.

68. An network-enabled productivity application for allowing a user to create word processing document having network-base a functionality, comprising:
native productivity application code for generating a word processing document;
a native script engine in communication with said native productivity application code, wherein said native script engine is capable of executing at least one macro; and
network-functionality code for providing network-based functionality within the word processing document in conjunction with said at least one macro.

69. A network-enabled productivity application for allowing a user to create a word processing document with network-based functionality, comprising:
native productivity application code;
a native script engine in communication with said native productivity application code, wherein said native script engine enables execution of one or more macros; and
an add-in package, comprising:
an interface for communicating with said productivity application;
a library comprising a plurality of user tools, said user tools exposed to a user through a user interface, said user tools configured to provide network-based functionality within a word processing document;
a library comprising a plurality of developer tools, said developer tools exposed to the user through said user interface, said developer tools configured to enable the creation of the word processing document with network-based functionality; and
a productivity application extender in communication with said user tools, said productivity application extender configured to provide network-functionality services and application services within said productivity application.

70. A method of augmenting a productivity application with network-based functionality, comprising:
receiving custom network-based functionality to add network-based operations to a productivity application;
linking said network-based functionality to said productivity application; and embedding at least one network-enabling object within a word processing document maintained by said productivity application.

71. A method of augmenting a productivity application, comprising:
storing software code for network-based functionality in a platform configured for use with a suitable operating system, said code for network-based functionality adding capability for network-based functionality to an existing productivity application;
transmitting said software code to a remote terminal operating said productivity application for allowing a user to launch and access network-based functionality from within a word processing document maintained by said productivity application.

72. The method of claim 71, further comprising obtaining network-functionality software before said storing, wherein said network-functionality software facilitates said storing of code for network-based functionality within the productivity application.

73. The method of claim 72, wherein said network-functionality software includes a developer tool set for enabling development of an Internet application within the productivity application by providing a means for creating code necessary for embedding at least one network-enabling object in said word processing document.

74. The method of claim 73, wherein the word processing document includes the Internet application.

75. A method of augmenting a productivity application, comprising:
launching a software platform to allow authoring by a user of custom network-based functionality, said network-based functionality designed to add network-based operations to a word processing document;
linking at least one network-enabling object to said productivity application for allowing the user to access and launch network-based functionality from within said productivity application, said linking taking place upon instruction from said user; and
deploying said network-based functionality upon instruction from said user, wherein said deployment allows activation of said at least one network-enabling object from within said productivity application by said user.

76. A method for transmitting a software package to augment a productivity application with network-based functionality, comprising:
establishing a connection with a remote terminal at a central server having access to a software package for augmenting a productivity application on the remote terminal with network-based operations; and
transmitting the software package to said remote terminal.

77. The method of claim 76, further comprising authenticating the identity of a user operating said remote terminal prior to said transmitting.

78. A method for transmitting a software package to augment a productivity application with network-based functionality, comprising:
receiving a login request from a remote client;
receiving a download request from said remote client to download said software package from a web server;
receiving authentication information from said remote client by web server;
verifying the authentication information of said remote client; and
serving the requested software package to said remote client, said software package comprising network-functionality software for augmenting a productivity application for launching network-based functionality from therein and embedding at least one network-enabling object for network-based functionality in a word processing document maintained by said productivity application.

79. A method of augmenting a productivity application with a plurality of network-based services, comprising:
obtaining network-functionality software, said network-functionality software including a library of routines to provide network-based functionality within a word processing document opened in the productivity application; and
installing said network-functionality software for use with said productivity application.

80. A method of augmenting a productivity application with a plurality of network-based user tools, comprising:
obtaining user tools containing a library of files enabling use of network-based functionality within a word processing document opened in the productivity application; and
installing said user tools on a local client.

81. A method for creating a network-enabling object to provide network-based functionality to a word processing document, comprising:
receiving an information model that provides information for conforming a network-enabling object therewith;
developing the network-enabling object to provide network-based functionality;
conforming said network-enabling object with said information model; and
placing said network-enabling object in an appropriate location of a system architecture for use in providing network-based functionality to a productivity application maintaining a word processing document.

82. A method for creating a network-enabling object to provide network-based functionality, comprising:
creating a Component Object Module (COM) control;
importing a service library;
authoring custom functionality as a component, wherein said functionality is configured to enable access to network-based functionality from a productivity application maintaining a word processing document; and
registering said component as a COM component of the service library.

83. A method for creating a network-enabling object to provide network-based functionality to a productivity application for operating a word processing document, comprising:
creating a Component Object Module (COM) control;
importing a service library;
receiving an information model, wherein said information model provides information for conforming the created network-enabling object therewith;
authoring custom functionality as a component, wherein said functionality is configured to enable access to network-based functionality;
registering said component as a COM component of the service library; and
placing said network-enabling object in an appropriate location of a system architecture for allowing access to network content through a word processing document maintained by a productivity application.

84. A method for creating a network-enabling object to provide network-based functionality to a productivity application maintaining a word processing document, comprising:
selecting a network-enabling object from a library of network-enabling objects;
downloading the selected network-enabling object onto a computing device;
installing the downloaded network-enabling object;
launching a productivity application for manipulating a word processing document; and
adjusting settings for the productivity application to include said installed network-enabling object.

85. The method of claim 84, wherein said library comprises a plurality of files accessible from at least one of a web site, a File Transfer Protocol (FTP) site and a software medium.

86. The method of claim 84, further comprising opening the word processing document after said launching the productivity application.

87. The method of claim 86, wherein the network-enabling object is embedded in said word processing document after said opening of the productivity application.

88. The method of claim 84, wherein the network-enabling object is embedded within said productivity application to augment said productivity application.

89. The method of claim 84, wherein the network-enabling object is placed on said computing device as a distinct icon for launching said network-based functionality from any software resident on the computing device.

90. A method for creating a network-enabling object to provide network-based functionality to a word processing document, comprising:
selecting a network-enabling object from a library of network-enabling objects, wherein said library comprises a plurality of files accessible from at least one of a web site, File Transfer protocol (FTP) site and a software medium;
downloading the selected network-enabling object onto a computing device;
installing the downloaded network-enabling object on the computing device;
launching a productivity application on the computing device;
opening a word processing document from said productivity application; and
embedding said network-enabling object in said word processing document.

91. A method for downloading a network-enabling object to a computing device, comprising:
establishing a connection with a server having a library of network-enabling objects stored therein;
selecting a library of network-enabling objects;
transmitting a request for downloading a network-enabling object from said library of network-enabling objects, the network enabling object for allowing a word processing document to receive and manipulate network content within a word processing document; and
receiving the network-enabling object.

92. A method for downloading network-enabling objects to a computing device, comprising:
receiving a login request from a remote client;
exposing a library of network-enabling objects to said client;
receiving a request from said client for downloading a network-enabling object from said library of network-enabling objects, the network enabling object for allowing a word processing document to receive network content;
authenticates said remote client; and
transmitting the requested network-enabling object to said client.

93. A network-enabling object for providing network-based functionality to a word processing document productivity application, comprising:
initializing code for initializing the network-enabling object;
launching code for launching network-based functionality within a word processing document after said initializing code; and
user interface code for displaying of the network-enabling object in an appropriate location of a window, after launching.

94. The network-enabling object of claim 86, further comprising a registration code for registering said object as a COM component of a service library said initializing.

95. A network-enabling object for providing network-based functionality to a word processing document productivity application, comprising:
initialization code for launching network-based functionality from within a word processing document productivity application; and run-time code for providing the network-based functionality in real-time.

96. A computer productivity application having network-based functionality, comprising:
native code for a productivity application, said native code provided with network-based functionality and non-network-based functionality, wherein said network-based functionality provides network-based operations within a word processing document maintained by the productivity application and said non-network-based functionality provides non-network-based functionality to the word processing document.

97. A productivity application having network-based functionality, comprising:
user interface code;
code for providing network-based functionality from within said productivity application, said network-based functionality exposed to a user through a said user interface code;
code for providing non-network functionality from within said word processing document productivity application, said non-network functionality exposed to the user by said user interface code; and
native code for the productivity application, said native code embedded with said network-based functionality and said non-network-based functionality for access within a word processing document maintained by said productivity application.

98. The productivity application of claim 97, wherein said code for providing network-based functionality further comprises a library comprising a plurality of user tools, said user tools exposed to the user by said user interface, code said user tools configured to provide the network-based functionality within the word processing document.

99. The productivity application of claim 90, wherein said code for providing network-based functionality further comprises a library including a plurality of developer tools, said developer tools exposed to a user by said user interface code, said developer tools configured to provide said network-based functionality within the productivity application for embedding the network based functionality in the word processing document.

100. A word processing document productivity application having network based functionality, comprising:
native productivity application code for complementing non-network based functionality;
a native object model in communication with said native productivity application code;
a native script engine in communication with said native productivity application code, wherein said native script engine provides functionality to native scripts;
code for providing network-based functionality from within said word processing document productivity application;
code for providing non-network functionality from within said word processing document productivity application; and user interface code allowing a user to activate said network-based functionality and said non-network functionality.

101. The word processing document productivity application of claim 100, wherein said network-based functionality is exposed to the user by said user interface code.

102. The word processing document productivity application of claim 100, wherein said non-network functionality is exposed to the user by said user interface code.

103. The word processing document productivity application of claim 100, wherein said code for providing network-based functionality comprises a library of user tools for use by a user to implement said network based functionality.

104. The word processing document productivity application of claim 103, wherein said user tools are exposed to said user through said user interface.

105. The word processing document productivity application of claim 104, wherein said code for providing said network-based functionality comprises a library of developer tools including tools for creating a word processing document with network-based functionality.

106. The word processing document productivity application of claim 105, wherein said developer tools are exposed to said user by said user interface code, said developer tools providing the ability to embed code for said network-based functionality within said word processing document by making a selection of a task.

107. The word processing document productivity application of claim 106, wherein said code for providing network-based functionality comprises a library of network-connectivity tools.

108. A method of creating a word processing document productivity application having network-based functionality, comprising:
authoring native code for a word processing document productivity application, said native code configured to provide non-network functionality and network-based functionality, said network-based functionality including the ability to access network based content within a word processing document; and
distributing said native code for use by a user.

109. The method of claim 108, wherein said native code comprises:
a native object model, and
a native script engine in communication with said native object model, wherein said native script engine for executing network-based functionality within said word processing document productivity application.

110. A method of creating a word processing document productivity application having network-based functionality, comprising:
generating network-based functionality in a software platform for providing network-based operations to a word processing document productivity application;
generating non-network-based functionality in the software platform; and
generating native code for the word processing document productivity application, said native code embedded with said network-based functionality and said non-network-based functionality.

111. A method of creating a word processing document productivity application having network-based functionality, comprising:
authoring native code for a word processing document productivity application said native code configured to provide non-network functionality and network-based functionality in a platform configured for use with an operating system, said network-based functionality being capable of providing real-time access to dynamic network-based content from a network within a word processing document; and
distributing said native code for use by a user.

112. A method of creating a word processing document productivity application having network-based functionality, comprising:
generating network-based functionality in a platform configured for use with an operating system, said network-based functionality for providing network-based operations to the word processing document productivity application;
generating non-network-based functionality in a platform configured for use with said operating system; and
generating native code for the word processing document productivity application, said native code embedded with said network-based functionality and said non-network-based functionality for providing non-network-based operations and network-based operations from said word processing document productivity application.

113. A method of creating a word processing document productivity application having network-based functionality, comprising:
generating code for network-based functionality in a software platform for providing network-based operations to a word processing document productivity application;
generating code for non-network-based functionality in the software platform, said code for non-network-based functionality comprising a native object model and a native script engine; and
generating native code for the word processing document productivity application, said native code embedded with said network-based functionality and said non-network-based functionality.

114. The method of claim 113, wherein said code for network-based functionality comprises a library of user tools, said user tools configured to provide network-based functionality including at least one of:
page scraping; and
stock quotes in real time.

115. The method of claim 114, wherein said code for network-based functionality comprises a productivity application extender in communication with said user tools, said productivity application extender configured to provide at least one of:
document packaging, caching, data initialization, and command routing.

116. The method of claim 115, wherein said code for network-based functionality comprises a library of developer tools, said developer tools configured to provide at least one of:
layout utilities, forms management, query management, a data modeler, and a packaging assistant.

117. A method of creating a word processing document productivity application having network-based functionality, comprising:
receiving code in a platform for network-based functionality to provide network-based operations to a word processing document productivity application;
receiving code in the platform for non-network-based functionality to provide non-network-based operations to the word processing document productivity application; and
receiving native code for the word processing document productivity application in the platform, wherein said native code is embedded with said network-based functionality and said non-network-based functionality.

118. A method of creating a word processing document productivity application having network-based functionality, comprising:
receiving code in a software platform for custom network-based functionality to provide network-based operations to a word processing document productivity application;
receiving code in the software platform for custom non-network-based functionality to provide non-network-based operations to the word processing document productivity application, said code for non-network-based functionality comprising a native object model, and a native script engine; and
receiving native code for the word processing document productivity application, said native code embedded with said network-based functionality and said non-network-based functionality.

119. A system for providing a combination of network-based services and non-network-based services within a word processing document productivity application, comprising:
a non-network component that is interpretable by a word processing document productivity application;
a network component that is capable of providing real-time access to network-based services, and
code associated with said word processing document productivity application for interpreting said network component for allowing access to said network-based services within the word processing document productivity application.

120. The system of claim 119, wherein said code for said network-based services are received over a network.

121. The system of claim 120, wherein said network-based services provide dynamic network-based content to a word processing document which is opened within the word processing document productivity application.

122. The system of claim 121, wherein said dynamic network-based content is accessible in real-time from within the word processing document opened in the word processing document productivity application.

123. The system of claim 122, wherein said code comprises:
an extender routine to support base functionality of said network component; and
developer tools for developing the word processing document with network-enabling objects embedded therein.

124. The system of claim 123, wherein said developer tools enable creation of Internet applications using said word processing document productivity application by providing means for embedding at least one network-enabling object in the word processing document.

125. The system of claim 124, wherein said developer tools are accessible from within the word processing document productivity.

126. The system of claim 124, wherein said developer tools comprises a user interface to expose said developer tools to a user.

127. The system of claim 126, wherein said user interface is a toolbar that exposes a plurality of tool sets to the user.

128. The system of claim 126, wherein said user interface is exposed to the user within the word processing document productivity application, said user interface appearing in addition to a standard toolbar of the word processing document productivity application.

129. The system of claim 124, wherein said extender routines are provided as a component object model component.

130. A system for providing a combination of network-based services and non-network based services within a word processing document productivity application, comprising:
a non-network component that is interpretable by a word processing document productivity application;
a network component that is capable of providing access to network-based services over a network, wherein said network-based services provide dynamic network-based content to a word processing document opened within the word processing document productivity application;
extender routines to support base functionality of said network component, said extender routines capable of interpreting said network component for allowing access to said network-based services within the word processing document productivity application; and
developer tools for providing the capability for developing a word processing document with network-enabling objects embedded therein, said developer tools accessible within the word processing document productivity application.

131. The system of claim 130, wherein said extender routines are provided separately from external to the word processing document productivity application.

132. A system for providing a combination of network-based services and non-network based services within a word processing document productivity application, comprising:
a network component that is capable of providing access to network-based services, said network-based services being received from a network for utilization within the word processing document productivity application, said first component providing real-time content from the network; and
a non-network component for providing non-network-based services within said word processing document productivity application.

133. The system of claim 132, wherein said non-network component is capable of providing static content.

134. The system of claim 133, wherein said network-based services provide dynamic network-based content to a word processing document which is opened within the word processing document productivity application.

135. The system of claim 134, wherein said dynamic network-based content is updated in real-time within the word processing document, while maintaining said static data.

136. The system of claim 135, wherein said first component comprises developer tools, said developer tools providing the capability for developing the word processing document with network-enabling objects embedded therein.

137. The system of claim 136, wherein said developer tools enable creation of an Internet application using said word processing document production application by embedding network-enabling objects in the word processing document.

138. The system of claim 137, wherein said developer tools comprises a user interface to display said developer tools to a user.

139. The system of claim 138, wherein said user interface is a toolbar that displays a plurality of tool sets to the user within the word processing document productivity application.

140. A system for providing a combination of network-based services and non-network based services within a network-enabled word processing document productivity application, comprising:
means for providing non-network based functionality;
means for providing real-time access to network-based services; and
means for allowing access to said network-based services within the network-enabled word processing document productivity application.

141. A system for providing a combination of network-based services and non-network-based services within a word processing document productivity application, comprising:
means for providing non-network based functionality that is interpretable by a word processing document productivity application;
means for providing access to network-based services over a network in communication with said means for providing non-network-based functionality;
means to support base functionality of said network-based services, wherein said means to support base functionality is capable of interpreting said means for providing access to network-based services; and
means for embedding network-enabling objects in a word processing document which is accessible from within the word processing document productivity application.

142. A system for providing a combination of network-based services and non-network based services within a word processing document productivity application, comprising:
means for providing access to network-based services over a network for utilization within the word processing document productivity application, said means for providing access to network-based services further for providing real-time content from the network; and
means for providing non-network-based services within said word processing document productivity application.

143. A method for providing network-based functionality to a word processing document embedded with network-enabling objects, comprising:
receiving a request from a remote client to receive network-based functionality, said remote client having network-enabling software for embedding a network enabling object within a word processing document; and
transmitting, to said remote client, software code for implementing desired network-based functionality, in response to the request.

144. The method of claim 143, further comprising authenticating said remote client after receiving said request from the remote client.

145. The method of claim 144, further comprising providing a secure connection to said client after said authenticating.

146. A method for providing network-based functionality to a word processing document embedded with at least one network-enabling object, said word processing document opened in a productivity application, the method comprising:
receiving a request from a remote client to receive network-based functionality for a word processing document, said remote client having locally-stored, requisite network-enabling software;
authenticating said remote client;
providing a secure connection to said client; and
transmitting said network-based functionality for installation through said network-enabling software to said remote client.

147. The method of claim 146, wherein said network-enabling software is executed on said remote client with said productivity application.

148. A method for providing network-based functionality to a word processing document embedded with at least one network-enabling object, said word processing document being executed on a remote client, the remote client in connection with a server providing support for the network-based functionality, the method comprising:
receiving a login request from a remote client;
receiving a request for network-enhanced functionality from said remote client;
transmitting said request to a web server extender;
providing security authentication services to verify and authenticate said remote client by said web server extender; and
transmitting requested network-enhanced functionality to said remote client for embedding network functionality within a word processing document.

149. A method for providing network-based functionality to a word processing document embedded with at least one network-enabling object, comprising:
receiving a login request from a remote client;
authenticating said remote client;
establishing a secure connection with said client;
receiving information from said client to determine whether said remote client has requisite network-enabling software stored locally; and
transmitting to said client, code for implementing network-based within a word processing document.

150. A method for providing network-based functionality to a word processing document having a network-enabling object, comprising:
providing a secure connection to said client;
transmitting a query to said remote client to determine whether said remote client has network-enabling software stored locally;
transmitting requisite network-enabling software to said remote client; and
providing said client with desired network-based functionality through said network-enabling software for implementation within the word processing document.

151. A method for providing network-based functionality to a word processing document having a network-enabling object, comprising:
providing a secure connection to said client;
receiving a request for network-enhanced functionality from said remote client;
transmitting said request to a web server extender; and
transmitting requested network-enhanced functionality to said remote client for implementation within a word processing document.

152. A method for receiving network-based functionality in a word processing document embedded with network-enabling objects, said word processing document being maintained on a remote client, the remote client connecting to a server providing support for the network-based functionality, the method comprising:
sending a login request to a server providing network-based functionality;
providing authenticating information;
establishing a secure connection to said server;
sending a request for appropriate network-based functionality to said server; and
receiving requested network-based functionality for implementation within a word processing document.

153. A method for receiving network-based functionality in a word processing document embedded with a network-enabling object, said word processing document being stored on a remote client, the remote client in communication with a server providing support for the network-based functionality, the method comprising:
sending a login request to a server providing network-based functionality;
providing authenticating information;
establishing a secure connection to said server;
receiving requisite network-enabling software from said server;
sending a request for appropriate network-based functionality; and
receiving requested network-based functionality for implementation within a word processing document.

154. A method for receiving network-based functionality in a word processing document embedded with a network-enabling object, said word processing document being stored on a remote client, the remote client connecting to a server providing support for the network-based functionality, the method comprising:
sending a login request to a server;
sending a request for network-enhanced functionality to said server;
receiving security authentication services from said server for verification and authentication; and
receiving requested network-enhanced functionality for implementation in a word processing document.

155. A system for providing support for network-based functionality, comprising:
a memory; and
a processor disposed in communication with said memory, said processor configured to:
receive a login request from a remote client;
authenticate said remote client; and
provide said client with desired network-based functionality for implementation within a word processing document.

156. A system for providing network-based functionality to personal computer documents embedded with network-enabling objects, comprising:
a memory;
a processor disposed in communication with said memory, said processor configured to:
receive a login request from a remote client,
authenticate said remote client,
establish a secure connection with said client after authentication, and
provide said client with network-based functionality for implementation within a word processing document.

157. A method, performed by a computer, for populating a network-enabled word processing document, comprising:
receiving a selection of one of: a cell or an insertion point within a word processing document;
receiving a parameter for a network query, the parameter corresponding to network-based content;
retrieving network-based content corresponding to the parameter; and
populating the word processing document with the network-based content based on the selection.

158. The method of claim 157, wherein said parameter comprises at least one of:
a network address for retrieving said network-based content, a name of said network-based content, and a type of said network-based content.

159. The method of claim 157, wherein said network-based content is static.

160. The method of claim 157, wherein said network-based content is dynamic.

161. The method of claim 160, further comprising:
receiving an indication of a change in said retrieved network-based content; and
populating the word processing document with the change in said network-based content.

162. The method of claim 160, further comprising:
automatically re-populating the word processing document with dynamically-changing content in real time.

163. The method of claim 160, further comprising:
re-populating the word processing document with dynamically-changing content at predetermined intervals.

164. The method of claim 163, wherein said predetermined intervals are selected by a user.

165. The method of claim 157, wherein said query is a predefined query.

166. The method of claim 157, wherein said query is defined by a user.

167. A computer-readable medium, encoded with processing instructions for implementing a method, performed by a computer, for populating a network-enabled word processing document, the method comprising:
receiving a selection of one of: a cell and an insertion point of a word processing document;
receiving a parameter for a network query, the parameter corresponding to network-based content;
retrieving network-based content corresponding to the parameter; and
populating the word processing document with the network-based content based on the selection.

168. An apparatus for populating a cell of a network enabled word processing document, comprising:
means for receiving a selection of one of: a cell and an insertion point in a word processing document;
means for receiving a parameter for a network query, the parameter corresponding to network-based content;
means for retrieving network-based content corresponding to the parameter; and
means for populating the word processing document with the network-based content based on the selection.

169. An apparatus for populating a cell of a network-enabled word processing document comprising:
a processor; and
a memory in communication with the processor, the memory for storing a plurality of processing instructions for directing a processor to:
receive a selection of one of: a cell and an insertion point in a word processing document;
receive a parameter for a network query, the parameter corresponding to network-based content;
retrieve network-based content corresponding to the parameter; and
populate the word processing document with the network-based content based on the selection.

170. A method for transmitting network-based content to a user through a network-enabled word processing document productivity application, comprising:
receiving a request from a user for network-based content over a computer network;
determining a network address for said network-based content;
retrieving said network-based content from a server corresponding to the network request; and
transmitting the network-based content to the user for display in one of: a cell and an insertion point of a network-enabled word processing document.

171. The method of claim 170, further comprising:
authenticating the user prior to the transmitting step.

172. The method of claim 170, wherein the request is received from a network-enabled object embedded in a word processing document operated by the user.

173. The method of claim 170, wherein said determining further comprises:
receiving the request from the user including a network address for the network-based content.

174. The method of claim 170, wherein said network-based content is static.

175. The method of claim 170, wherein said network-based content is dynamic.

176. The method of claim 175, wherein said transmitting further comprises:
streaming the network-based content to the client in real time.

177. The method of claim 175, wherein said transmitting further comprises:
transmitting said network-based content at predetermined intervals.

178. The method of claim 177, wherein said predetermined interval are defined by the user.

179. A computer-readable medium encoded with processing instructions for implementing a method, performed by a computer, for transmitting network-based content to a user through a network-enabled word processing document productivity application, the method comprising:
receiving a request from a user for network-based content over a computer network;
determining a network address for said network-based content;
retrieving said network-based content from a server corresponding to the network request; and
transmitting the network-based content to the user for display in one of: a cell and an insertion point of a network-enabled word processing document.

180. An apparatus for transmitting network-based content to a user through a network-enabled word processing document productivity application, comprising:
means for receiving a request from a user for network-based content over a computer network;
means for determining a network address for said network-based content;
means for retrieving said network-based content from a server corresponding to the network request; and
means for transmitting the network-based content to the user for display in one of: a cell and an insertion point of a network-enabled word processing document.

181. An apparatus for transmitting network-based content to a user through a network-enabled word processing document productivity application, comprising:
a processor; and
a memory in communication with the processor, the memory encoded with a plurality of processing instructions allowing the processor to:
receive a request from a user for network-based content over a computer network;
determine a network address for said network-based content;
retrieve said network-based content from a server corresponding to the network request; and
transmit the network-based content to the user for display in one of: a cell and an insertion point of a network-enabled word processing document.

182. A method for receiving network-based content in a word processing document productivity application, comprising:
receiving a network-enabling object over a computer network connection;
embedding the network-enabling object in a word processing document maintained by a word processing document productivity application;
defining a data parameter corresponding to network-based content;
designating at least one of: a cell and an insertion point for displaying said network-based content;
receiving the network-based content corresponding to the data parameter from a network server; and
displaying said network-based content based on said designating.

183. The method of claim 182, wherein the network-based content is static.

184. The method of claim 182, wherein said network-based content is dynamic.

185. The method of claim 182, further comprising:
defining an interval to update said network based content.

186. The method of claim 182, further comprising:
transmitting login information prior to said receiving said network-based content.

187. A computer-readable medium encoded with processing instructions for implementing a method, performed by a computer, for receiving network-based content in a word processing document productivity application, the method comprising:
receiving a network-enabling object over a computer network connection;
embedding the network-enabling object in a word processing document maintained by a word processing document productivity application;
defining a data parameter corresponding to network-based content;
designating at least one of: a cell and an insertion point for displaying said network-based content;
receiving the network-based content corresponding to the data parameter from a network server; and
displaying said network-based content based on said designating.

188. An apparatus for receiving network-based content in a word processing document productivity application, comprising:
means for receiving a network-enabling object over a computer network connection;
means for embedding the network-enabling object in a word processing document maintained by a word processing document productivity application;
means for receiving a defined data parameter corresponding to network-based content;
means for designating at least one of: a cell and an insertion point for displaying said network-based content;
means for receiving the network-based content corresponding to the data parameter from a network server; and
means for displaying said network-based content based on said designating.

189. An apparatus for receiving network-based content in a word processing document productivity application, comprising:
a processor; and
a memory in communication with the processor, the memory for storing a plurality of processing instructions allowing the processor to:
receive a network-enabling object over a computer network connection;
embed the network-enabling object in a word processing document maintained by a word processing document productivity application;
receive a defined data parameter corresponding to network-based content;
receive a designation of at least one of: a cell and an insertion point for displaying said network-based content;
receive the network-based content corresponding to the data parameter from a network server; and
display said network-based content based on said designation.

190. A method for transmitting network-based content to a word processing document productivity application, comprising:
transmitting a network-enabling object over a computer network connection to a client, the network -enabling object for embedding in a word processing document maintained by a word processing document productivity application;
receiving a data parameter corresponding to a request for network-based content;
retrieving said network-based content from a content provider; and
transmitting said network-based content to said client for display in at least one of: a cell and an insertion point of the word processing document.

191. The method of claim 190, wherein the network-based content is static.

192. The method of claim 190, wherein said network-based content is dynamic.

193. The method of claim 192, further comprising:
receiving from said client an interval to update said network based content.

194. The method of claim 192, wherein said transmitting network-based content further comprises:
transmitting said network-based content in real time.

195. The method of claim 190, further comprising:
authenticating login information prior to said transmitting said network-based content.

196. A computer-readable medium encoded with processing instructions for implementing a method, performed by a computer, for transmitting network-based content to a word processing document productivity application, the method comprising:
transmitting a network-enabling object over a computer network connection to a client, the network-enabling object for embedding in a word processing document maintained by a word processing document productivity application;
receiving a data parameter corresponding to a request for network-based content;
retrieving said network-based content from a content provider; and
transmitting said network-based content to said client for display in at least one of: a cell and an insertion point of the word processing document.

197. An apparatus for transmitting network-based content to a word processing document productivity application, comprising:
means for transmitting a network-enabling object over a computer network connection to a client, the network-enabling object for embedding in a word processing document maintained by a word processing document productivity application;
means for receiving a data parameter corresponding to a request for network-based content;
means for retrieving said network-based content from a content provider; and
means for transmitting said network-based content to said client for display in at least one of: a cell and an insertion point of the word processing document.

198. An apparatus for transmitting network-based content to a word processing document productivity application, comprising:
a processor; and
a memory in communication with said processor, the memory for storing a plurality of processing instructions directing the processor to:
transmit a network-enabling object over a computer network connection to a client, the network-enabling object for embedding in a word processing document maintained by a word processing document productivity application;
receive a data parameter corresponding to a request for network-based content;
retrieve said network-based content from a content provider; and
transmit said network-based content to said client for display in at least one of: a cell and an insertion point of the word processing document.
